(19) United States
(12) Patent Application Publication
(10) Pub. No.: US 2026/0265457 A1
(43) Pub. Date: Sep. 10, 2026

(54) POLYCARBONATE FOAM MATERIAL, PRECURSOR COMPOSITION AND KIT THEREOF

(71) Applicants: BASQUE CENTER FOR MACROMOLECULAR DESIGN AND ENGINEERING, POLYMAT FUNDAZIOA, Donostia-San Sebastián, Gipuzkoa (ES); UNIVERSIDAD DEL PAÍS VASCO/EUSKAL HERRIKO UNIBERTSITATEA, Leioa, Vizcaya (ES)

(72) Inventors: Tansu ABBASOGLU, Leioa, Vizcaya (ES); Lourdes IRUSTA MARITXALAR, Leioa, Vizcaya (ES); Haritz SARDÓN MUGURUZA, Donostia-San Sebastián, Gipuzkoa (ES)

(21) Appl. No.: 19/162,324

(22) PCT Filed: Mar. 26, 2024
(86) PCT No.: PCT/EP2024/058041

§ 371 Date: Sep. 4, 2025

(30) Foreign Application Priority Data
Mar. 27, 2023 (EP) 23382286.5

(51) Int. Cl. C08G 64/38; C08G 64/02; C08G 64/18; C08J 3/24; C08J 9/00; C08J 9/12; C08K 3/34

(52) U.S. Cl. CPC C08G 64/38; C08G 64/0208; C08G 64/183; C08J 3/246; C08J 9/0066; C08J 9/125; C08K 3/346; C08G 2110/0083; C08J 2203/10; C08J 2369/00; C08J 2483/06

(57) ABSTRACT

A composition useful for the formation of polycarbonate foams with no need of external blowing agent and a process for the preparation of a polycarbonate foam, a polycarbonate foam resulting from the process and a kit of parts for the preparation of a polycarbonate foam are disclosed.

### FIELD OF THE INVENTION

The present invention relates to a composition useful for the formation of polycarbonate foams with no need of external blowing agent. The invention also relates to a process for the preparation of a polycarbonate foam, to a polycarbonate foam resulting from said process and to a kit of parts for the preparation of a polycarbonate foam.

### BACKGROUND

Polymer foam materials are used worldwide in a broad range of applications, including insulation, sealants, packaging, safety, cushioning, etc. These materials comprise gas molecules entrapped within the network of polymer chains of the polymer material, thus forming a cellular structure. The preparation of foam materials thus usually requires the use of blowing agents in charge of generating the cellular structure of the foam material, said structure appearing during a transition of the material (phase transition or polymerization). The cellular structure in a polymer foam provides a material with low density, increased thermal and acoustic insulation, and increased relative stiffness with respect to the original polymer. Polyurethane foam materials are in particular very popular, as those are prepared easily by the polyaddition of polyisocyanates and macropolyols. The decarboxylation ability of isocyanates in the presence of water allows for the fabrication of polyurethane foams in a one-step process involving simultaneous reactions of polyurethane formation and gas generation. In this regard, such polyurethane foams are called self-blowing foams, as no external blowing agent needs to be added to promote the formation of the cellular structure of the foam material. However, the use of hazardous and toxic isocyanate compounds is of concern and there is a need for more sustainable alternative precursors of polymer foam materials.

As discussed by Jin F. and co-workers in “Recent Trends of Foaming in Polymer Processing: A Review.” Polymers 2019, 11(6), 953, several alternative polymeric matrices such as polystyrene (PS), poly(vinyl chloride) (PVC), propylene (PP), can be foamed. However, to create cells inside those matrices, the addition of an external physical or chemical blowing agent is mandatory. Externally-blown foams cannot mimic cell uniformity and properties of self-blowing foams, and the addition of external blowing agents increases the cost and complexity of the industrial production process. Therefore, the provision of novel self-foaming systems that allow avoiding the use of isocyanates leading to adverse impacts on human health and the environment, is of great interest.

Polycarbonate materials can be obtained from both natural and renewable sources, and are inherently suitable for recycling, i.e., (1) reuse via reprocessing (mechanical recycling) using the dynamics of carbonate bonds, as well as (2) chemical decomposition and re-synthesis (chemical recycling) via acid-catalyzed hydrolysis or biodegradation. Therefore, polycarbonate materials could potentially have a defined circular end-of-life scenario, which has been highlighted as a solution for the plastic build-up and accumulation. Additionally, polycarbonates are industrially relevant polymers (e.g. aromatic polycarbonates in aircraft and safety glasses) with approximately 3 million tons of annual production. Consequently, polycarbonate foam materials can represent an attractive sustainable alternative to polyurethane foams.

Methods for the production of polycarbonate foams are known in the art. For instance, V. Kumar and co-workers disclose in “Production of Microcellular Polycarbonate Using Carbon Dioxide for Bubble Nucleation”. Journal of Engineering for Industry 1994, 116 (4), 413-420 a process for the preparation of polycarbonate foam materials using carbon dioxide as external blowing agent. The disclosed process comprises the step of placing polycarbonate sheets in an atmosphere of carbon dioxide, which promotes the dissolution of carbon dioxide within the polymer network. Said dissolution process exhibits a plasticizer effect and lowers the glass transition temperature of the polycarbonate material. Once the sheet is saturated with carbon dioxide, it is heated, provoking an expansion of the entrapped gas, which leads to the formation of a cellular microstructure by bubble nucleation. According to the authors, the density of the resulting foam material can decrease up to 10% the density of the starting material.

Another method for the preparation of polycarbonate foam materials is disclosed by Gendron and co-workers in “Continuous Extrusion of Microcellular Polycarbonate.” Polym. Eng. Sci. 2003, 43 (7), 1361-1377. The disclosed process employs a commercially available polycarbonate material and carbon dioxide or n-pentane as an external blowing agent. The mixing of the polymer with the blowing agent is achieved by means of an extrusion process. A similar process is disclosed in N. Weingart and co-workers in “Expanded Polycarbonate (EPC)—A New Generation of High-Temperature Engineering Bead Foams”. Polymers 2020, 12 (10), 2314, whereby the blowing agent, i.e. carbon dioxide, is mixed with the melt polymer within the dosing area of the extruder. The produced foam polymer is disclosed as having suitable mechanical properties for a broad range of applications, such as performance materials in automotive industry. However, all the processes disclosed in the art for the preparation of a polycarbonate foam employ external blowing agents such as carbon dioxide.

Chinese patent CN 102 911 350 discloses the use of cross-linked 5,5′-oxydimethylene bis(5-ethyl-1,3-dioxane) in biodegradable materials.

US patent U.S. Pat. No. 11,603,444 B2 discloses foaming compositions comprising a compound having cyclic carbonate groups and a foaming agent that is a combination of a carbamate salt and an amine compound.

From what is disclosed in the art, it derives that there is still a need for providing compositions for the production of polycarbonate foams whereby the foam is formed with no need for an external blowing agent, in particular whereby the polymer is formed concomitantly with the blowing agent.

### SUMMARY OF THE INVENTION

After exhaustive research, the inventors have developed a composition suitable for forming a polycarbonate foam material without the need for addition of a gaseous external blowing agent. The composition of the invention comprises in particular two different types of polycarbonate precursors, a first polycarbonate precursor comprising at least one 5-membered cyclic carbonate moiety; and a second polycarbonate precursor comprising at least one 6-membered cyclic carbonate moiety. The inventors have found that water and thiol compounds react selectively with said first polycarbonate precursor comprising at least one 5-membered cyclic carbonate moiety when placed in a mixture of the first and second polycarbonate precursors, thereby opening the 5-membered ring to produce an alcohol compound and releasing one molecule of carbon dioxide, which can act as blowing agent generated in situ. The alcohol compound resulting from the lyse reaction of the first polycarbonate precursor comprising at least one 5-membered cyclic carbonate moiety with water or the thiol compound exhibits sufficient reactivity upon heating to promote the ring-opening polymerization of the second polycarbonate precursor, thereby producing a polycarbonate compound.

The invention is thus based on the observed differing orthogonal reactivity of water or thiols and alcohols toward cyclic carbonates with different ring sizes. Notably, water and a thiol nucleophile show no or little reactivity towards ring-opening of six-membered cyclic carbonates but show reactivity with five-membered cyclic carbonates, which undergo the decarboxylative S-alkylation to form thioethers or the decarboxylative hydrolysis of the carbonate group. The decarboxylation of the five-membered cyclic carbonate generates CO₂, and a reactive alcohol intermediate, which in turn promotes the ring-opening polymerization (ROP) of the six-membered cyclic carbonate for the construction of the polycarbonate matrix. It was found in particular that the use of polythiols and/or second polycarbonate precursors comprising a plurality of 6-membered cyclic carbonate moieties promotes the formation of cross-linked polymer chains.

Thus, in a first aspect, the invention relates to a composition comprising:
(a) a first component that is a compound A1 comprising in its molecular formula one or more moieties of formula (I)

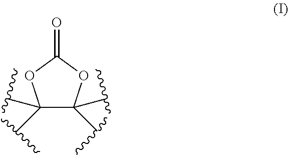 [SMILES: *C1(*)OC(=O)OC1(*)*]

wherein each wavy line represents the position to which the moiety of formula (I) is attached to the remainder of the compound of formula A1, provided that at least one of said attachments is to a hydrogen atom;
(b) a second component that is water or a compound A2 comprising in its molecular formula a plurality of thiol groups or masked precursors thereof;
(c) a third component that is a compound A3 comprising in its molecular formula one or more moieties of formula (II)

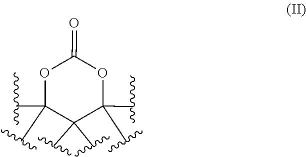 [SMILES: *C1(*)OC(=O)OC(*)(*)C1(*)*]

wherein each wavy line represents the position to which the moiety of formula (II) is attached to the remainder of the compound of formula A3;
(d) optionally, a polyol compound, and
(e) optionally, a catalytically effective amount of a catalyst suitable for the reaction of water or a thiol group of the compound A2 with an aliphatic carbon atom of the moiety of formula (I) in the compound A1.

A second aspect of the invention relates to a process for the preparation of a polycarbonate foam, said process comprising the steps of:
(i) providing a composition comprising the compound A1; water or compound A2; and compound A3; said compounds being as defined in the first aspect of the invention,
(ii) optionally, heating the composition resulting from (i) so as to provide a liquid composition,
(iii) adding a catalytically effective amount of a catalyst as defined in the first aspect of the invention to the composition resulting from (i) or (ii), and
(iv) heating the composition provided in step (iii) so as to produce a polycarbonate foam.

The third aspect of the invention relates to a polycarbonate foam obtainable by the process of the second aspect of the invention.

A kit for the preparation of a polycarbonate foam is also part of the invention. A fourth aspect of the invention thus relates to a kit for forming a polycarbonate foam comprising a plurality of parts, the kit comprising the compound A1; water or compound A2; and compound A3; said compounds being as defined in the first aspect of the invention; and a catalytically effective amount of a catalyst as defined in the first aspect of the invention, whereby the catalyst is provided in a different part than water or the compound A2 or the compound A1.

As mentioned above, the process of the second aspect of the invention comprises the following steps:
Step 1: the second component comprising at least one group of formula —XH wherein X is S or O reacts with the first component according to the following reaction scheme:

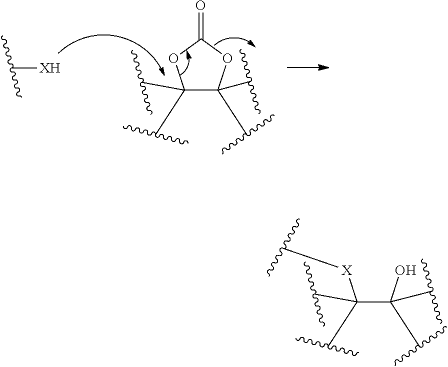

thus producing an alcohol compound
Step 2: the alcohol compound produced in step 1 reacts with the third component according to the following reaction scheme:

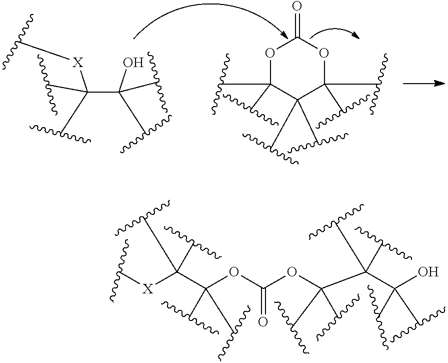

Step 3: the alcohol compound produced in step 2 may further react with further molecules of the third component to form a polycarbonate, which represents a propagation step of the ring opening polymerization reaction. The product of said step thus comprises in its molecular formula a fragment of formula

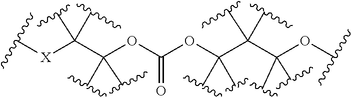

A fifth aspect of the invention thus relates to a polycarbonate foam comprising in its molecular formula at least one moiety of formula (IV)

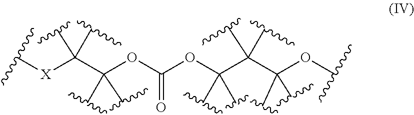

wherein X is S or O and each wavy line represents the position to which the moiety of formula (IV) is attached to the remainder of the molecular formula of the polycarbonate foam, said moiety having preferably the formula (IVa)

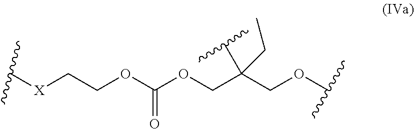

As will be obvious to the skilled person, the products of the third and fifth aspects refer to the same product.

The polycarbonate foam of the invention may be treated with surface functionalization agents in order to provide functional materials, such as hydrophobic materials, antibacterial materials, flame retarded materials or cross-linkable materials. Said agents may be reacted with the free hydroxyl groups comprised in the polycarbonate foam of the invention, for instance by silanization, i.e. formation of strong Si—O bonds. Thus, as defined above, the sixth aspect of the invention relates to a process comprising the steps of:
(i) providing a polycarbonate foam according to the third or fifth aspect of the invention;
(ii) subjecting the polycarbonate foam of step (i) to silanization, preferably by contacting the polycarbonate foam of step (i) with a compound of formula FG-Z-SiLG₃ wherein each LG is a group independently, preferably simultaneously, selected from halo, preferably chloro, and (C₁-C₆)alkyloxy;
Z is a diradical deriving from a (C₁-C₃₀)alkyl group; and
FG is selected from the group consisting of hydrogen, SH, vinyl, P(O)(OR¹⁴)₂, and ⁺NR¹⁵R¹⁶R¹⁷R¹⁸ wherein each one of R¹⁴, R¹⁵, R¹⁶, R¹⁷ and R¹⁸ is independently selected from (C₁-C₆)alkyl groups.

A seventh aspect of the invention relates to a polycarbonate foam obtainable by the process of the sixth aspect of the invention.

In specific embodiments of the sixth and seventh aspects, in particular when FG is hydrogen, the inventors have found that the produced polycarbonate foam is highly hydrophobic and exhibits strong affinity for organic phases and/or oils. Such material is thus useful in the removal of an organic phase and/or oils from mixtures of these components with an aqueous phase. Thus, an eight aspect of the invention relates to a method for removing an organic phase and/or an oil from a mixture of an aqueous phase with an organic phase and/or an oil comprising the steps of:
(i) contacting a polycarbonate foam obtainable by the process of the seventh aspect of the invention when FG is hydrogen with said organic phase and/or oil to produce a foam soaked with said organic phase and/or oil; and
(ii) separating said foam soaked with said organic phase and/or oil from the aqueous phase by means of solid-liquid separation techniques, such as filtration or decantation.

### BRIEF DESCRIPTION OF THE DRAWINGS

FIG. 1 shows (top) photographs and (bottom) Scanning Electron Microscopy pictures of a polycarbonate foam prepared from a composition as disclosed in example 1 and comprising a polyol compound that is a Poly(caprolactone) triol and no additive.

FIG. 2 shows (top) photographs and (bottom) Scanning Electron Microscopy pictures of a polycarbonate foam prepared from a composition as disclosed in example 1 and comprising a polyol compound that is a Poly(caprolactone) triol and laponite as additive.

FIG. 3 shows (top) photographs and (bottom) Scanning Electron Microscopy pictures of a polycarbonate foam prepared from a composition as disclosed in example 1 and comprising a polyol compound that is a Poly(caprolactone) triol and di(trimethylolpropane) as additive.

FIG. 4 shows (top) photographs and (bottom) Scanning Electron Microscopy pictures of a polycarbonate foam prepared from a composition as disclosed in example 1 and comprising a polyol compound that is Sovermol 750® and Tegomer E-Si® as additive.

FIG. 5 shows (top) photographs and (bottom) Scanning Electron Microscopy pictures of a polycarbonate foam prepared from a composition as disclosed in example 1 and comprising a polyol compound that is Sovermol 750® and laponite as additive.

FIG. 6 shows (top) photographs and (bottom) Scanning Electron Microscopy pictures of a polycarbonate foam prepared from a composition as disclosed in example 1 and comprising a polyol compound that is pentaerythritol ethoxylate (15/4 EO/OH) and Tegomer E-Si® as additive.

FIG. 7 shows a photograph a polycarbonate foam prepared from a composition as disclosed in example 1 and comprising a polyol compound that is Sovermol 805®.

FIG. 8 shows (left column) a photograph and (middle and right column) Scanning Electron Microscopy pictures of a polycarbonate foam prepared from a composition as disclosed in example 2 and comprising a polyol compound that is a Poly(caprolactone) triol.

FIG. 9 shows (left column) a photograph and (middle and right column) Scanning Electron Microscopy pictures of a polycarbonate foam prepared from a composition as disclosed in example 2 and comprising a polyol compound that is a Poly(caprolactone) triol and laponite as additive.

FIG. 10 shows (left column) a photograph and (middle and right column) Scanning Electron Microscopy pictures of a polycarbonate foam prepared from a composition as disclosed in example 2 and comprising a polyol compound that is Sovermol 750® with no additive.

FIG. 11 shows (left column) a photograph and (middle and right column) Scanning Electron Microscopy pictures of a polycarbonate foam prepared from a composition as disclosed in example 1 and comprising a polyol compound that is Sovermol 750®.

FIG. 12 shows a) the conversion (expressed as a percentage) over time (expressed in minutes) of 5,5-dimethyl-1,3-dioxan-2-one when in contact with 3,6-dioxa-1,8-octanedithiol (hollow hexagonal symbols—no or little reactivity) or triethylene glycol (filled hexagonal symbol—reactivity) and b) the conversion (expressed as a percentage) over time (expressed in minutes) of ethylene carbonate when in contact with 3,6-dioxa-1,8-octanedithiol (filled pentagonal symbols—reactivity) or triethylene glycol (hollow pentagonal symbol—no or little reactivity). Conditions: [SH] or [OH]/[carbonate]=1, 5 mol % of DBU vs the cyclic carbonate. Reactions at 70° C. in anhydrous DMSO.

FIG. 13 shows photographs of polycarbonate foams prepared from compositions free of polyol compound as disclosed in example 3.

FIG. 14 shows (left and middle columns) photographs and (right column) Scanning Electron Microscopy pictures of a polycarbonate foam prepared from a composition as disclosed in example 1 and comprising a polyol compound that is Priplast™ 3162.

FIG. 15 shows (left and middle columns) photographs and (right column) Scanning Electron Microscopy pictures of a polycarbonate foam prepared from a composition as disclosed in example 1 and comprising a polyol compound that is Cardolite NX-9004.

FIG. 16 shows (top) photographs and (bottom) Scanning Electron Microscopy pictures of a polycarbonate foam prepared from a composition as disclosed in example 1 and comprising a polyol compound that is Cardolite NX-9004.

FIG. 17 shows (top) photographs and (bottom) Scanning Electron Microscopy pictures of a polycarbonate foam prepared from a composition as disclosed in example 1 and comprising a polyol compound that is Cardolite NX-9004 and Tegomer E-Si as additive.

FIG. 18 shows (top) photographs and (bottom) Scanning Electron Microscopy pictures of a polycarbonate foam prepared from a composition as disclosed in example 2 and comprising a polyol compound that is Priplast™ 3162.

FIG. 19 shows (top) photographs and (bottom) Scanning Electron Microscopy pictures of a polycarbonate foam prepared from a composition as disclosed in example 2 and comprising a polyol compound that is Cardolite NX-9004.

FIG. 20 shows (left and middle columns) photographs of material according to Entry 1 of Table 6 before and after treatment with OTS having received drops of a dyed aqueous phase and (right column) Scanning Electron Microscopy pictures of the treated polycarbonate foam of Entry 1 of Table 6.

FIG. 21 shows a method for the separation of dichloromethane from water employing the surface-treated polycarbonate foam of Example 5 Table 6 Entry 1: (a) introduction of the foam in a vial comprising a biphasic system comprising water and dichloromethane, the dashed line representing the phase separation; (b) contacting the foam with the dichloromethane phase of the biphasic system, the dashed line representing the phase separation; (c) foam soaked with organic phase within the aqueous phase and (d) aqueous phase (left) separated from organic phase, the latter being comprised within the polycarbonate foam (right).

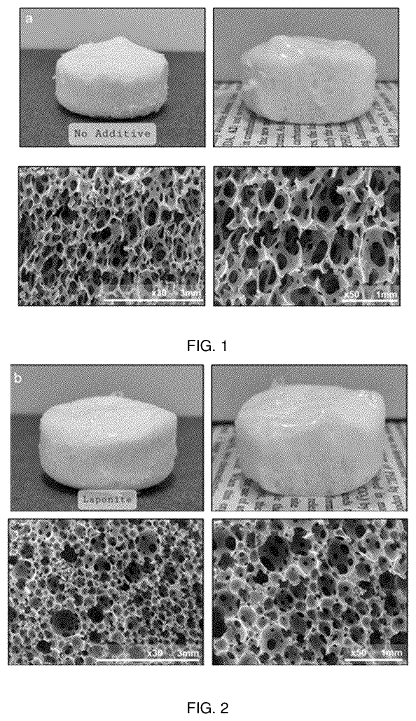

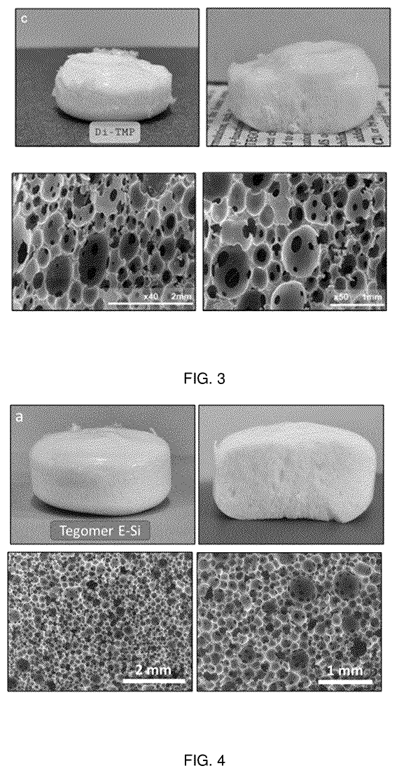

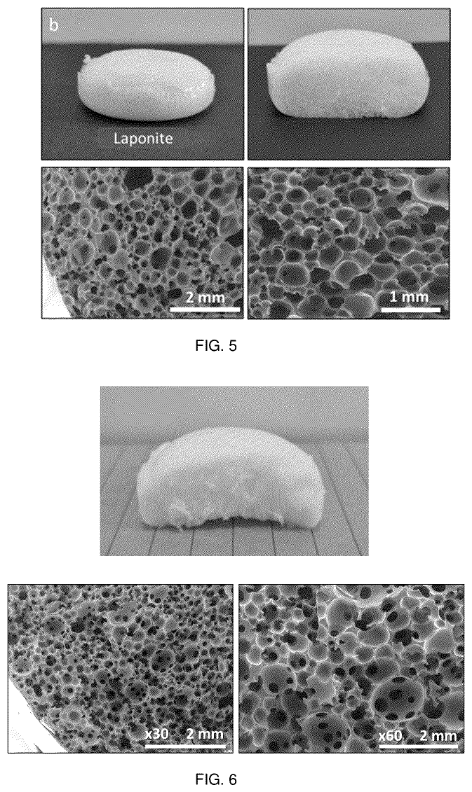

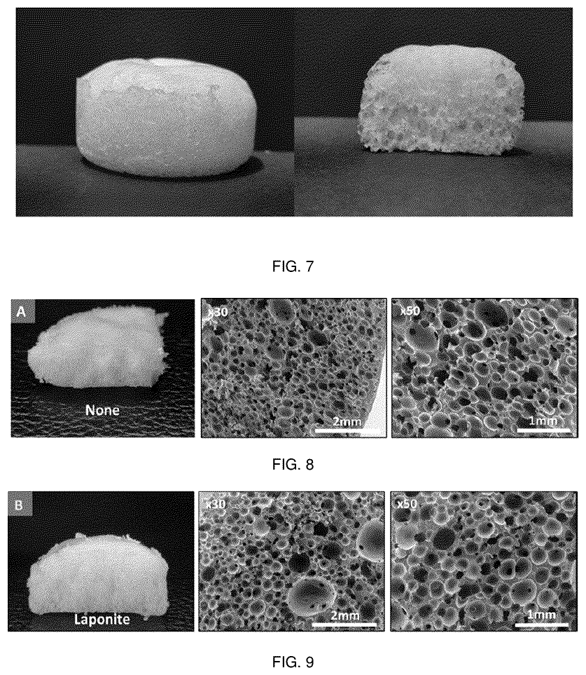

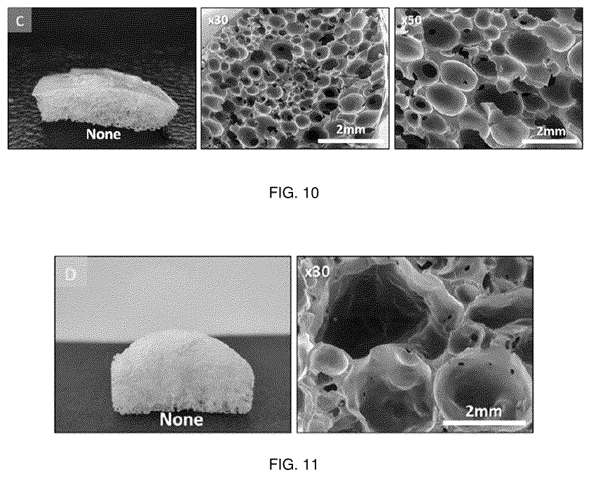

### DETAILED DESCRIPTION

All terms as used herein in this application, unless otherwise stated, shall be understood in their ordinary meaning as known in the art. Other more specific definitions for certain terms as used in the present application are as set forth below and are intended to apply uniformly throughout the specification and claims unless an otherwise expressly set out definition provides a broader definition.

For the purposes of the invention, any ranges given include both the lower and the upper end-points of the range. Ranges or values given, such as temperatures, times, molar ratio, volume ratio and the like, should be considered approximate when they are defined by the term “about” (i.e. with a 5% margin of variation around indicated point).

In the context of the invention, the term “polyol” refers to a substance comprising in its molecular formula a plurality of hydroxyl groups. These groups can react with a carbonate group comprised in a compound. In the context of the invention, the polyol comprises in its molecular formula at least two OH groups, such as from 2 to 50. Examples of polyol compounds include, but are not limited to: organic polyols, i.e. a polyol compound comprising carbon-hydrogen bonds in its molecular formula, more particularly polyether-polyester co-polymer polyol compound, aromatic polyols, a (C₁-C₆)alkane comprising at least one carbon atom attached to three or four radicals of formula —CH₂OR¹³ wherein each R¹³ group is independently selected from hydrogen, a polyethylene glycol chain and a polyester chain such as a polycaprolactone chain. Aromatic polyols preferably refer to a compound comprising at least one aryl group, preferably from 1 to 5, and comprising from 2 to 50 OH groups.

In the context of the invention, the term “diradical” refers to a molecular fragment having two attachment points to the remainder part of a molecule. Thus, a diradical is divalent. In the context of the invention, a diradical is said to “derive” from a monovalent group (that is, a group having one attachment point to the remainder part of a molecule) when the second attachment point of said diradical is the result of the abstraction of a hydrogen atom comprised in said monovalent group.

In the context of the invention, the term “alkyl” refers to an aliphatic saturated hydrocarbon chain that is linear or branched and having the number of carbon atoms defined in the claims and the description. Non-limiting examples of alkyl groups include, for instance, methyl, ethyl, n-propyl, i-propyl, n-butyl, i-butyl, t-butyl, n-pentyl, neo-pentyl, hexyl, heptyl, octyl, nonyl, decyl, undecanyl and dodecanyl.

In the context of the invention, the term “cycloalkyl” refers to an aliphatic saturated cyclic hydrocarbon and having the number of carbon atoms defined in the claims and the description. Non-limiting examples of cycloalkyl groups include, for instance, cyclopropyl, cyclobutyl, cyclopentyl, cyclohexyl, cycloheptyl, and cyclooctyl.

In the context of the invention, the term “alkenyl” refers to an aliphatic unsaturated hydrocarbon chain that is linear or branched and having the number of carbon atoms defined in the claims and the description wherein at least two carbon atoms are linked through a double carbon-carbon bond. Non-limiting examples of alkenyl groups include, among others, vinyl, methylvinyl, propen-1-yl, propen-2-yl, butenyl, and iso-butenyl.

In the context of the invention, the term “alkylcarbonyl” refers to a saturated linear or branched aliphatic hydrocarbon group having the number of carbon atoms indicated in the description or in the claims which is attached to the remainder of the molecular formula through a carbonyl group (C═O).

In the context of the invention, the term “alkylcarbonyloxy” refers to a saturated linear or branched aliphatic hydrocarbon group having the number of carbon atoms indicated in the description or in the claims which is attached to the remainder of the molecular formula through a carboxyl group (—COO—) and wherein the alkyl chain is attached to the carbon atom of the carboxyl group.

In the context of the invention, the term “alkyloxycarbonyl” refers to a saturated linear or branched aliphatic hydrocarbon group having the number of carbon atoms indicated in the description or in the claims which is attached to the remainder of the molecular formula through a carboxyl group (—OOC—) and wherein the alkyl chain is attached to the non-carbonyl oxygen atom of the carboxyl group.

In the context of the invention, the term “alkyloxy” refers to a saturated linear or branched aliphatic hydrocarbon group having the number of carbon atoms indicated in the description or in the claims which is attached to the remainder of the molecular formula through an oxy group (—O—).

In the context of the invention, the term “alkylthio” refers to a saturated linear or branched aliphatic hydrocarbon group having the number of carbon atoms indicated in the description or in the claims which is attached to the remainder of the molecular formula through an thioxy group (—S—).

In the context of the invention, the term “alkylamino” refers to a saturated linear or branched aliphatic hydrocarbon group having the number of carbon atoms indicated in the description or in the claims which is attached to the remainder of the molecular formula through an amino group (—NR—), being R a hydrogen or a (C₁-C₆)alkyl.

In the context of the invention, the term “alkylcarbonylamino” refers to a saturated linear or branched aliphatic hydrocarbon group having the number of carbon atoms indicated in the description or in the claims which is attached to the remainder of the molecular formula through a carboxamyl group (—CONH—) and wherein the alkyl chain is attached to the carbon atom of the carboxamyl group.

In the context of the invention, the term “alkylaminocarbonyl” refers to a saturated linear or branched aliphatic hydrocarbon group having the number of carbon atoms indicated in the description or in the claims which is attached to the remainder of the molecular formula through a carboxamyl group (—NHOC—) and wherein the alkyl chain is attached to the nitrogen atom of the carboxamyl group.

In the context of the invention, the term “viscosity” and “complex viscosity” refers to a measure of the total resistance to flow as a function of angular frequency (w) and is given by the quotient of the maximum stress amplitude and maximum strain rate amplitude in a small amplitude oscillatory rheological testing.

In an embodiment, the first aspect of the invention relates to a composition comprising:
(a) a first component that is a compound A1 comprising in its molecular formula one or more moieties of formula (I)

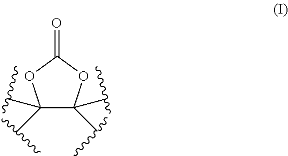 [SMILES: *C1(*)OC(=O)OC1(*)*]

wherein each wavy line represents the position to which the moiety of formula (I) is attached to the remainder of the compound of formula A1;
(b) a second component that is water or a compound A2 comprising in its molecular formula a plurality of thiol groups or masked precursors thereof;
(c) a third component that is a compound A3 comprising in its molecular formula one or more moieties of formula (II)

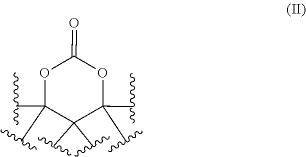 [SMILES: *C1(*)OC(=O)OC(*)(*)C1(*)*]

wherein each wavy line represents the position to which the moiety of formula (II) is attached to the remainder of the compound of formula A3;
(d) optionally, a polyol compound, and
(e) optionally, a catalytically effective amount of a catalyst suitable for the reaction of water or a thiol group of the compound A2 with an aliphatic carbon atom of the moiety of formula (I) in the compound A1.

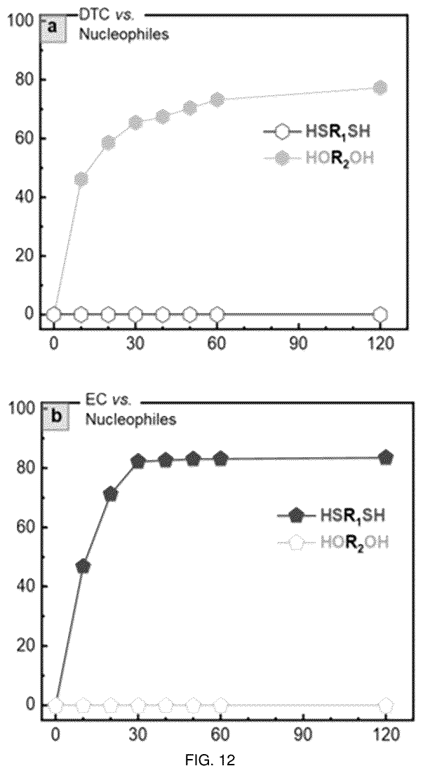

The composition according to the first aspect of the invention is suitable for forming a polycarbonate foam. As mentioned above, it is believed that said polycarbonate foam forms by virtue of the orthogonal reactivity of the second component of the composition with respect to the carbonate groups of the first and third components of the composition. The observed orthogonal reactivity unexpectedly leads to the second component to react selectively with the moieties of formula (I) of the first component, leading to the formation of carbon dioxide and an alcohol derivative, said alcohol derivative being in turn suitable for reacting in cascade with the third component in a selective manner. Such orthogonal reactivity is demonstrated in FIG. 12.

The composition of the invention advantageously allows generating the blowing agent in situ, by reaction of the second component with the first component, which generates carbon dioxide. The composition of the invention thus allows preparing a polycarbonate foam comprising carbon dioxide entrapped within the polycarbonate material.

Thus, in a particular embodiment, the composition of the first aspect of the invention does not comprise any further blowing agent than the combination of the first and second components.

It has unexpectedly been found that increasing viscosity prior to expansion of the foam reduces cell wall rupture, leading to harder foams. Therefore, in a more preferred embodiment, the composition of the first aspect of the invention has a viscosity of at least 20 Pa·s, more preferably of at least 100 Pa·s, when measured after a time of 540 seconds of heating said composition at 70° C. (in particular the composition is heated at 70° C. for 540 seconds, and the viscosity is measured at said second 540); such as from any of these values up to 100000 Pa·s, more particularly up to 40000 Pa·s; even more particularly up to 10000 Pa·s; even more particularly up to 1000 Pa·s and even more particularly up to 500 Pa·s. Viscosities may be measured according to the procedure described in Example 4 of the present application.

In a preferred embodiment of the first aspect of the invention, the compound of formula A1 comprises in its molecular formula one or more moieties of formula (I) wherein each wavy line represents the position to which the moiety of formula (I) is attached to hydrogen atoms or organic groups, said organic groups optionally comprising heteroatoms.

In a more preferred embodiment of the first aspect of the invention, the compound of formula A1 comprises in its molecular formula one moiety of formula (I) wherein each wavy line represents the position to which said moiety of formula (I) is attached to hydrogen atoms or organic groups, said organic groups optionally comprising heteroatoms.

In a more preferred embodiment of the first aspect of the invention, the compound of formula A1 is a compound of formula (Ib)

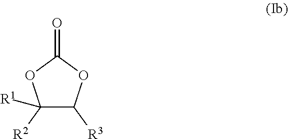

wherein each one of R¹, R² and R³ is independently selected from the group consisting of hydrogen, halo, (C₁-C₆)alkyl, (C₂-C₆)alkenyl, benzyl and (C₃-C₈)cycloalkyl. More preferably, each one of R¹, R² and R³ is independently selected from the group consisting of hydrogen, (C₁-C₆)alkyl, and (C₃-C₃)cycloalkyl.

In a more preferred embodiment of the first aspect of the invention, the compound of formula A1 is a compound of formula (Ia)

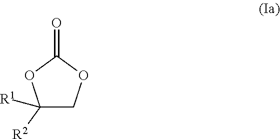

wherein each one of R¹ and R² is independently selected from the group consisting of hydrogen, halo, (C₁-C₆)alkyl, (C₂-C₆)alkenyl, benzyl and (C₃-C₈)cycloalkyl. More preferably, each one of R¹ and R² is independently selected from the group consisting of hydrogen, (C₁-C₆)alkyl, and (C₃-C₈)cycloalkyl.

Even more preferably, the compound of formula A1 is ethylene carbonate. It is advantageous as ethylene carbonate is readily accessible, by reaction of ethylene oxide with carbon dioxide.

Compounds of formula A1 may be prepared by reaction of the corresponding epoxide with carbon dioxide or may be purchased from commercial sources. For instance, both ethylene carbonate and propylene carbonate may be purchased from Sigma-Aldrich, TCl Chemicals, ThermoFisher among other sources.

In a more preferred embodiment, the composition of the first aspect of the invention comprises a molar amount ratio of compound A2 thiol groups or water hydroxyl groups to compound A1 moieties of formula (I) from 1.0:3.0 to 1.0:0.8; preferably from 0.8:1.0 to 1.0:0.8. More particularly, the molar amount of said thiol groups or said hydroxyl groups to the molar amount of said moieties of formula (I) is about 1:1, such as 1:1.

In a further preferred embodiment, the composition of the first aspect of the invention comprises a molar amount ratio of compound A3 moieties of formula (II) to compound A1 moieties of formula (I) of at least 0.8:1, preferably at least 1:1. However, the presence of an excess amount of compound A3 moieties of formula (II) over compound A1 moieties of formula (I) has unexpectedly been observed to provide ideal foaming conditions, ultimately leading to harder foams. Thus, more preferably, said ratio is greater than 1:1, preferably of at least 1.5:1, such as between 1.5:1 and 5:1, more particularly of between 1.5:1 and 2.5:1.

Alternatively, it has also been unexpectedly observed that harder foams can be obtained when the composition of the first aspect of the invention comprises a polyol compound, without the need of increasing the molar amount ratio of compound A3 moieties of formula (II) to compound A1 moieties of formula (I), although this may also be done as described above.

In further preferred embodiments, the composition of the first aspect is one wherein the compound of formula A1 is in an amount of from 6% to 20% in weight of the composition. Preferably, the compound of formula A1 is in an amount of from 10% to 15% in weight of the composition. This is particularly the case when the compound A1 is a compound of formula (Ib) or (Ia) as defined above.

The composition of the first aspect of the invention comprises a third component that is a compound A3 comprising in its molecular formula one or more moieties of formula (II), such as from one to six moieties of formula (II).

In a further preferred embodiment, the composition of the first aspect of the invention comprises a third component comprising in its molecular formula two or more moieties of formula (II), such as from two to six moieties of formula (II).

In a further preferred embodiment, the composition of the first aspect of the invention comprises a third component that is a compound A3 of formula (II′)

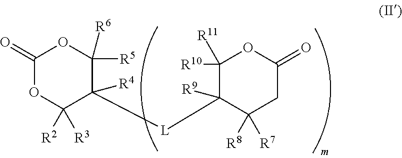

wherein m is 0 or 1,
each one of R², R³, R⁴, R⁵, R⁶, R⁷, R⁸, R⁹, R¹⁰ and R¹¹ is independently selected from the group consisting of hydrogen, halo, (C₁-C₆)alkyl, (C₂-C₆)alkenyl and (C₃-C₈)cycloalkyl; and
L is a diradical deriving from a group selected from the group consisting of (C₁-C₆)alkyl, (C₁-C₆)alkyloxy, (C₁-C₆)alkylamino, (C₁-C₆)alkyloxycarbonyl, (C₁-C₆)alkylaminocarbonyl, (C₁-C₆)alkylcarbonylamino, (C₁-C₆)alkylcarbonyloxy, (C₁-C₆)alkylthio, (C₂-C₆)alkenyl, a group of formula (C₁-C₆)alkyl-O—(C₁-C₆)alkyl, a group of formula (C₁-C₆)alkyl-S—(C₁-C₆)alkyl, a group of formula (C₁-C₆)alkyl-NR¹²—(C₁-C₆)alkyl wherein R¹² is hydrogen or (C₁-C₆)alkyl, a group of formula (C₁-C₆)alkyl-CONR¹²—(C₁-C₆)alkyl wherein R¹² is hydrogen or (C₁-C₆)alkyl, a group of formula (C₁-C₆)alkyl-NR¹²CO—(C₁-C₆)alkyl wherein R¹² is hydrogen or (C₁-C₆)alkyl, a group of formula (C₁-C₆)alkyl-OCO—(C₁-C₆)alkyl, a group of formula (C₁-C₆)alkyl-COO—(C₁-C₆)alkyl, a group of formula (C₁-C₆)alkyl-(O—(C₁-C₆)alkyl)ₙ-O wherein n is an integer of from 1 to 10, a group of formula G, a group of formula (C₁-C₆)alkyl-G, a group of formula (C₁-C₆)alkyl-G-(C₁-C₆)alkyl, wherein G is a ring system comprising from 1 to 3 rings.

In a further preferred embodiment, the composition of the first aspect of the invention comprises a third component that is a compound A3 of formula (IIa)

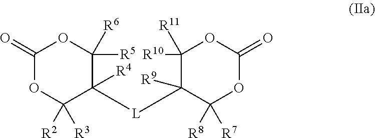

wherein each one of R², R³, R⁴, R⁵, R⁶, R⁷, R⁸, R⁹, R¹⁰ and R¹¹ is independently selected from the group consisting of hydrogen, halo, (C₁-C₆)alkyl, (C₂-C₆)alkenyl and (C₃-C₈)cycloalkyl; and
L is a diradical deriving from a group selected from the group consisting of (C₁-C₆)alkyl, (C₁-C₆)alkyloxy, (C₁-C₆)alkylamino, (C₁-C₆)alkyloxycarbonyl, (C₁-C₆)alkylaminocarbonyl, (C₁-C₆)alkylcarbonylamino, (C₁-C₆)alkylcarbonyloxy, (C₁-C₆)alkylthio, (C₂-C₆)alkenyl, a group of formula (C₁-C₆)alkyl-O—(C₁-C₆)alkyl, a group of formula (C₁-C₆)alkyl-S—(C₁-C₆)alkyl, a group of formula (C₁-C₆)alkyl-NR¹²—(C₁-C₆)alkyl wherein R¹² is hydrogen or (C₁-C₆)alkyl, a group of formula (C₁-C₆)alkyl-CONR¹²—(C₁-C₆)alkyl wherein R¹² is hydrogen or (C₁-C₆)alkyl, a group of formula (C₁-C₆)alkyl-NR¹²CO—(C₁-C₆)alkyl wherein R¹² is hydrogen or (C₁-C₆)alkyl, a group of formula (C₁-C₆)alkyl-OCO— (C₁-C₆)alkyl, a group of formula (C₁-C₆)alkyl-COO—(C₁-C₆)alkyl, a group of formula (C₁-C₆)alkyl-(O—(C₁-C₆)alkyl)ₙ-O wherein n is an integer of from 1 to 10, a group of formula G, a group of formula (C₁-C₆)alkyl-G, a group of formula (C₁-C₆)alkyl-G-(C₁-C₆)alkyl, wherein G is a ring system comprising from 1 to 3 rings.

In said embodiment, G is preferably a ring system comprising from 1 to 3 saturated, unsaturated or aromatic rings, the rings being isolated, bridged or fused and comprising from 3 to 8 members selected from the group consisting of C, CH, CH₂, N, O and S, the rings being further optionally substituted at any available position with a radical selected from the group consisting of (C₁-C₆)alkyl, halo, cyano, nitro and (C₁-C₆)alkyloxy.

G is more preferably a ring system comprising one saturated or aromatic ring comprising from 3 to 8 members selected from the group consisting of C, CH, and CH₂, the rings being further optionally substituted at any available position with a radical selected from the group consisting of (C₁-C₆)alkyl, halo, cyano, nitro and (C₁-C₆)alkyloxy.

In a further preferred embodiment, the composition of the first aspect of the invention comprises a third component that is a compound A3 of formula (IIa) as defined above wherein each one of R², R³, R⁴, R⁵, R⁶, R⁷, R⁸, R⁹, R¹⁰ and R¹¹ is independently selected from the group consisting of hydrogen, (C₁-C₆)alkyl, and (C₃-C₈)cycloalkyl.

In a further preferred embodiment, the composition of the first aspect of the invention comprises a third component that is a compound A3 of formula (IIa) as defined above wherein each one of R², R³, R⁵, R⁶, R¹, R⁸, R¹⁰ and R¹¹ is hydrogen and R⁴ and R⁹ are as defined above.

In a further preferred embodiment, the composition of the first aspect of the invention comprises a third component that is a compound A3 of formula (IIa) as defined above wherein each one of R², R³, R⁵, R⁶, R⁷, R⁸, R¹⁰ and R¹¹ is hydrogen and each one of R⁴ and R⁹ is independently a (C₁-C₆)alkyl such as an ethyl group.

In a further preferred embodiment, the composition of the first aspect of the invention comprises a third component that is a compound A3 of formula (IIa) as defined above wherein L is a diradical deriving from a group selected from the group consisting of (C₁-C₆)alkyl, (C₁-C₆)alkyloxy, (C₁-C₆)alkyloxycarbonyl, (C₁-C₆)alkylcarbonyloxy, (C₁-C₆)alkylthio, (C₂-C₆)alkenyl, a group of formula (C₁-C₆)alkyl-O—(C₁-C₆)alkyl, a group of formula (C₁-C₆)alkyl-S—(C₁-C₆)alkyl, a group of formula (C₁-C₆)alkyl-OCO—(C₁-C₆)alkyl, a group of formula (C₁-C₆)alkyl-COO—(C₁-C₆)alkyl, a group of formula (C₁-C₆)alkyl-(O—(C₁-C₆)alkyl)ₙ-O wherein n is an integer of from 1 to 10, a group of formula G, a group of formula (C₁-C₆)alkyl-G, a group of formula (C₁-C₆)alkyl-G-(C₁-C₆)alkyl, wherein G is a ring system comprising from 1 to 3 rings as defined above.

In a more preferred embodiment, the composition of the first aspect of the invention comprises a third component that is a compound A3 of formula (IIa) as defined above wherein L is a diradical deriving from a group selected from the group consisting of (C₁-C₆)alkyl, (C₁-C₆)alkyloxy, (C₁-C₆)alkyloxycarbonyl, (C₁-C₆)alkylcarbonyloxy, a group of formula (C₁-C₆)alkyl-O—(C₁-C₆)alkyl, a group of formula (C₁-C₆)alkyl-OCO—(C₁-C₆)alkyl, and a group of formula (C₁-C₆)alkyl-COO—(C₁-C₆)alkyl.

In an even more preferred embodiment, the composition of the first aspect of the invention comprises a third component that is a compound A3 of formula (IIa) as defined above wherein L is a diradical deriving from a group selected from the group consisting of (C₁-C₆)alkyl, a group of formula (C₁-C₆)alkyl-O—(C₁-C₆)alkyl, a group of formula (C₁-C₆)alkyl-OCO—(C₁-C₆)alkyl, and a group of formula (C₁-C₆)alkyl-COO—(C₁-C₆)alkyl.

In a yet more preferred embodiment, the composition of the first aspect of the invention comprises a third component that is a compound A3 of formula (IIa) as defined above wherein L is a diradical deriving from a group of formula (C₁-C₆)alkyl-O—(C₁-C₆)alkyl.

In a most preferred embodiment, the composition of the first aspect of the invention comprises a third component that is a compound A3 of formula (IIa) as defined above wherein L is a diradical of formula —CH₂—O—CH₂—.

In a more particular preferred embodiment, the composition of the first aspect of the invention comprises a third component that is a compound A3 of formula (IIa) as defined above wherein each one of R², R³, R⁵, R⁶, R¹, R⁸, R¹⁰ and R¹¹ is hydrogen, R⁴ and R⁹ are as defined above and L is a diradical deriving from a group of formula (C₁-C₆)alkyl-O—(C₁-C₆)alkyl.

In an even more particular preferred embodiment, the composition of the first aspect of the invention comprises a third component that is a compound A3 of formula (IIa) as defined above wherein each one of R², R³, R⁵, R⁶, R⁷, R⁸, R¹⁰ and R¹¹ is hydrogen, each one of R⁴ and R⁹ is independently a (C₁-C₆)alkyl such as an ethyl group and L is a diradical deriving from a group of formula (C₁-C₆)alkyl-O—(C₁-C₆)alkyl.

In a most particular preferred embodiment, the composition of the first aspect of the invention comprises a third component that is 5,5′-(oxybis(methylene))bis(5-ethyl-1,3-dioxan-2-one) of formula (IIa1)

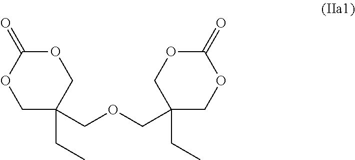 [SMILES: CCC1(COCC2(CC)COC(=O)OC2)COC(=O)OC1]

The compound of formula (IIa1) is a compound of formula (IIa) as defined above wherein each one of R², R³, R⁵, R⁶, R⁷, R⁸, R¹⁰ and R¹¹ is hydrogen, each one of R⁴ and R⁹ is an ethyl group and L is a diradical of formula —CH₂—O—CH₂—.

The compound of formula (IIa) may be prepared adapting the procedure for the synthesis of (IIa1) disclosed by Yang, L and co-workers in “Biodegradable Cross-linked Poly(trimethylene carbonate) Networks for Implant Applications: Synthesis and Properties”. Polymer 2013, 54, 2668-2675, page 2669 paragraph 2.2, incorporated herein by reference.

In an alternative preferred particular embodiment, the composition of the first aspect of the invention comprises a third component that is 5,5-dimethyl-1,3-dioxan-2-one.

In a further preferred embodiment, the composition of the first aspect of the invention comprises a molar amount ratio of compound A3 moieties of formula (II) to compound A2 thiol groups or water hydroxyl groups of at least 0.8:1, preferably at least 1:1. However, the presence of an excess amount of compound A3 moieties of formula (II) over compound A2 thiol groups or water hydroxyl groups has unexpectedly been observed to provide ideal foaming conditions, ultimately leading to harder foams. Thus, more preferably, said ratio is of greater than 1:1, preferably of at least 1.5:1, such as between 1.5:1 and 5:1, more particularly of between 1.5:1 and 2.5:1.

Alternatively, it has also been unexpectedly observed that harder foams can be obtained when the composition of the first aspect of the invention comprises a polyol compound, without the need of increasing the molar amount ratio of compound A3 moieties of formula (II) to compound A2 thiol groups or water hydroxyl groups, although this may also be done as described above.

The composition of the first aspect of the invention comprises a second component that is water or a compound A2 comprising in its molecular formula a plurality of thiol groups or masked precursors thereof.

In a further more preferred embodiment, in any embodiment described herein, the composition of the first aspect of the invention comprises a second component that is a compound A2 comprising in its molecular formula a plurality of thiol groups or masked precursors thereof, more preferably a compound A2 comprising in its molecular formula a plurality of thiol groups.

In the context of the invention, the compound A2 comprises preferably from 2 to 10 thiol groups or masked precursors thereof; more preferably from 2 to 4.

In a further more preferred embodiment, the composition of the first aspect of the invention comprises a second component that is a compound A2 comprising in its molecular formula from 2 to 6 thiol groups or masked precursors thereof.

Masked precursors of thiol groups are known in the art and include any functional group susceptible of delivering a thiol group in response to the action of an external stimulus. Known masked precursors of thiol groups include disulfides, xanthates, thioesters, thiocarbonates, dithiocarbonates, and trithiocarbonates.

In a further more preferred embodiment, the composition of the first aspect of the invention comprises a second component that is a compound A2 comprising in its molecular formula a plurality of thiol groups.

In a further more preferred embodiment, the composition of the first aspect of the invention comprises a second component that is a compound A2 comprising in its molecular formula from 2 to 6 thiol groups.

In a further more preferred embodiment, the composition of the first aspect of the invention comprises a second component that is a compound A2 comprising in its molecular formula 2 thiol groups. It has been observed that the resulting polycarbonate foam materials exhibit higher Young Modulus and Storage Modulus than when a compound A2 comprising more than two (e.g. 4) thiol groups is used.

In a further more preferred embodiment, the composition of the first aspect of the invention comprises a second component that is a compound A2 of formula C(H)ₓ(-Q-SH)_{y} wherein each Q is independently an organic diradical, preferably a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10; y is an integer from 2 to 4 and x is an integer from 0 to 2, such that the sum of x and y is equal to 4.

In a further more preferred embodiment, the composition of the first aspect of the invention comprises a second component that is a compound A2 of formula C(H)ₓ(-Q-SH)_{y} wherein each Q is simultaneously an organic diradical, preferably a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10; y is an integer from 2 to 4 and x is an integer from 0 to 2, such that the sum of x and y is equal to 4.

In a further more preferred embodiment, the composition of the first aspect of the invention comprises a second component that is a compound A2 of formula (H)ₓ(-Q₁-)CH₂(-Q₂-SH)₂ wherein each Q₁ and Q₂ is independently an organic diradical, preferably a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10.

In a preferred particular embodiment, the composition of the first aspect of the invention comprises a second component that is a compound A2 of formula (HS-Q₁-)CH₂(-Q₂-SH)₂ wherein each Q₁ and Q₂ is independently an organic diradical, preferably a diradical deriving from a radical selected from the group consisting of (C₁-C₆)alkyl and a group of formula (C₁-C₆)alkyl-(O—(C₁-C₆)alkyl)ₙ-O wherein n is an integer of from 1 to 10.

In a further preferred more particular embodiment, the composition of the first aspect of the invention comprises a second component that is a compound A2 that is 3,6-dioxa-1,8-octanedithiol. This compound may be purchased from commercial sources such as Sigma-Aldrich, TCl Chemicals, ABCR GmbH and Apollo Scientific Ltd.

In another preferred particular embodiment, the composition of the first aspect of the invention comprises a second component that is a compound A2 of formula (III)

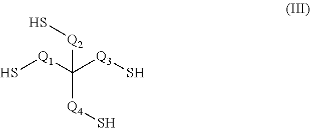

wherein each one of Q₁, Q₂, Q₃ and Q₄ is independently an organic diradical, preferably a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10.

In a further more preferred embodiment, the composition of the first aspect of the invention comprises a second component that is a compound A2 of formula (III) as defined above wherein Q₁, Q₂, Q₃ and Q₄ are the same diradical.

In a further more preferred embodiment, the composition of the first aspect of the invention comprises a second component that is a compound A2 of formula (III) as defined above wherein each one of Q₁, Q₂, Q₃ and Q₄ is independently a diradical deriving from a radical selected from the group consisting of (C₁-C₆)alkyloxy, (C₁-C₆)alkyloxycarbonyl, (C₁-C₆)alkylcarbonyloxy, and a group of formula (C₁-C₆)alkyl-(O—(C₁-C₆)alkyl)ₙ-O wherein n is an integer of from 1 to 10.

In a further more preferred embodiment, the composition of the first aspect of the invention comprises a second component that is a compound A2 of formula (III) as defined above wherein each one of Q₁, Q₂, Q₃ and Q₄ is independently a diradical deriving from a radical selected from the group consisting of (C₁-C₆)alkyloxycarbonyl, and (C₁-C₆)alkylcarbonyloxy; preferably, each one of Q₁, Q₂, Q₃ and Q₄ is independently a diradical deriving from a (C₁-C₆)alkylcarbonyloxy radical.

In a preferred more particular embodiment, the composition of the first aspect of the invention comprises a second component that is pentaerythritol tetrakis(3-mercaptopropionate). This compound may be purchased from commercial sources such as Sigma-Aldrich, TCl, ABCR GmbH and BOC Sciences.

In a further embodiment of the first aspect of the invention, the composition of the first aspect of the invention as defined in any embodiment described herein further comprises a polyol compound. Said polyol compound advantageously promotes the cross-linking of the formed polycarbonate material, thereby altering the rigidity of the formed polycarbonate. Said polyol compound reacts with the third component of the composition of the first aspect of the invention by ring opening polymerization. As will be obvious to the skilled person, the number of OH groups comprised in the polyol compound determines the number of polymer chains growing from said polyol compound. The molecular rigidity of the polyol compound also determines the rigidity of the formed polycarbonate. The skilled person will thus devise how to select an appropriate polyol compound to prepare a polycarbonate foam material having the desired mechanical properties.

In preferred embodiments, the polyol compound is one wherein each reactive hydroxyl group is attached to a —CH₂ group.

In further preferred embodiments, the polyol compound is one comprising from 2 to 10 OH groups, preferably from 1 to 5. Said OH groups are preferably reactive. Such OH groups are said to be “reactive” when they react with a six-membered cyclic carbonate compound, such as of formula IIa1, by nucleophilic ring opening reaction.

More preferably, the polyol compound has a molecular weight comprised between 200 and 10000, preferably between 500 and 1500, grams per mole.

In a preferred embodiment of the first aspect of the invention, the polyol compound is selected from the group consisting of a polyester polyol compound, a polyether polyol compound, a polyether-polyester co-polymer polyol compound, aromatic polyols, a (C₁-C₆)alkane comprising at least one carbon atom attached to three or four radicals of formula —CH₂OR¹³ wherein each R¹³ group is independently selected from hydrogen, a polyethylene glycol chain and a polyester chain such as a polycaprolactone chain, and mixtures thereof.

In some embodiments, aromatic polyols correspond to polyol compounds comprising one or more moieties of formula:

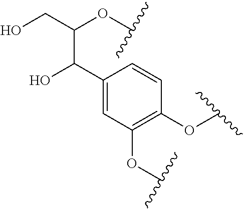 [SMILES: *Oc1ccc(C(O)C(CO)O*)cc1O*]

wherein each wavy line represents the position to which the moiety is attached to the remainder of the polyol compound.

Other suitable aromatic polyols are sold under the commercial names cardolite, such as Cardolite NX-9004, NX-5285 CNSL Polyol, NX-9104 CNSL Mannich Polyol.

Suitable polyester polyols are known in the art and include polyols of polycaprolactone, for instance compounds comprising a plurality of polycaprolactone moieties, and polyols of fatty acids, for instance compounds comprising one or more fatty acid moieties in their molecular formula. Examples of such polyol compounds include the compound with CAS 37652-56-2 and Priplast 3162.

Suitable polyether polyols are known in the art and include ethers of polyethylene glycol chains with (C₁-C₆) aliphatic polyols, such as trimethylolpropane, dimethylolpropane, 1,3-propane-diol and pentaerythtritol.

Suitable polyether-polyester co-polymer polyol compound are known in the art and correspond to oligomeric reaction products of epoxidized alkyl esters of fatty acids, such as epoxidized methyl esters of C₁₆-C₁₈ fatty acids, with (C₁-C₆) aliphatic polyols, such as trimethylolpropane, dimethylolpropane, 1,3-propane-diol and pentaerythtritol. Such compounds are commercially available and sold under the trademark Sovermol®.

Preferably, the polyol compound is selected from the group consisting of tetraether of pentaerythritol with polyethylene glycol, Poly(caprolactone) triol, Priplast 3162, Cardolite NX-9004, and Sovermol® 750.

In a preferred embodiment of the first aspect of the invention, the polyol compound is present in an amount such that the molar amount of OH groups in the polyol compound is equal to or lower than the molar amount of moieties of formula (II) in the third component of the composition.

In a further preferred embodiment of the first aspect of the invention, the polyol compound is present in an amount such that the molar ratio of OH groups in the polyol compound to the moieties of formula (II) in the third component of the composition is comprised from 1:10 to 9:10; preferably it is comprised from 1:5 to 2:3. In some embodiments said ratio is of about 1:4. In some embodiments said ratio is of about 1:2.

In a further preferred embodiment of the first aspect of the invention, the polyol compound is di-trimethylolpropane. It has been observed that polycarbonate foams made from a composition comprising said polyol exhibit higher compression stress values compared to an analogous foams made from the same composition deprived of said polyol.

In a preferred embodiment of the first aspect of the invention, the composition comprises a catalytically effective amount of a catalyst suitable for the reaction of water or a thiol group of the compound A2 with an aliphatic carbon atom of the moiety of formula (I) in the compound A1.

Any base known in the art suitable for abstracting a proton from the second component, such as tertiary amines or amidines, may be used in the composition as catalyst. In particular, said catalyst may be 1,5,7-Triazabicyclo[4.4.0]dec-5-ene or 1,8-diazabicyclo[5.4.0]undec-7-ene. Preferably, it is 1,8-diazabicyclo[5.4.0]undec-7-ene.

In a more preferred embodiment of the first aspect of the invention, the molar amount of compound A3 moieties of formula (II) to the molar amount of moieties of formula (I) in the compound A1 is greater than 1:1, preferably of at least 1.5:1, such as between 1.5:1 and 5:1, more particularly of between 1.5:1 and 2.5:1, even more particularly it is about 2:1, such as 2:1, and the molar amount of compound A2 thiol groups or water hydroxyl groups to compound A1 moieties of formula (I) is from 1.0:3.0 to 1.0:0.8; preferably, the molar amount of compound A2 thiol groups or water hydroxyl groups to compound A1 moieties of formula (I) is from 0.8:1.0 to 1.0:0.8, more particularly it is about 1:1, such as 1:1.

Alternatively, in a more preferred embodiment of the first aspect of the invention, the molar amount of compound A3 moieties of formula (II) to the molar amount of compound A2 thiol groups or water hydroxyl groups is greater than 1:1, preferably of at least 1.5:1, such as between 1.5:1 and 5:1, more particularly of between 1.5:1 and 2.5:1, even more particularly it is about 2:1, such as 2:1, and the molar amount of compound A2 thiol groups or water hydroxyl groups to compound A1 moieties of formula (I) is from 1.0:3.0 to 1.0:0.8; preferably, the molar amount of compound A2 thiol groups or water hydroxyl groups to compound A1 moieties of formula (I) is from 0.8:1.0 to 1.0:0.8, more particularly it is about 1:1, such as 1:1.

In a further preferred embodiment of the first aspect of the invention, the composition further comprising an additive. Such additive may be a texturizing agent, a stabilizer, a thickening agent, a flame retardant, an adhesion promoter, a foam hardener, an inorganic filler or a cross-linking agent such as epoxy containing compounds.

In a further preferred embodiment of the first aspect of the invention, the composition further comprising an additive that is selected from the group consisting of inorganic fillers, such as nanoclays or hydrotalcite, and cross-linking agents such as polyepoxy compounds, in particular of the polysiloxane type.

In an embodiment 1, the composition is the composition of the first aspect of the invention.

In an embodiment 2, the composition is according to embodiment 1, wherein the first component is a compound of formula (Ib) as described elsewhere herein.

In an embodiment 3, the composition is according to embodiment 2, wherein the first component is a compound of formula (Ia) as described elsewhere herein.

In an embodiment 4, the composition is according to embodiment 3, wherein the first component is ethylene carbonate.

In an embodiment 5, the composition is according to any one of embodiments 1 to 4, wherein the second component is a compound of formula C(H)ₓ(-Q-SH)_{y} as described elsewhere herein.

In an embodiment 6, the composition is according to any one of embodiments 1 to 5, wherein the second component is a compound of formula (HS-Q₁-)CH₂(-Q₂-SH)₂, as described elsewhere herein.

In an embodiment 7, the composition is according to any one of embodiments 1 to 5, wherein the second component is a compound of formula (III) as described elsewhere herein.

In an embodiment 8, the composition is according to embodiment 6, wherein the second component is 3,6-dioxa-1,8-octanedithiol.

In an embodiment 9, the composition is according to embodiment 7, wherein the second component is pentaerythritol tetrakis(3-mercaptopropionate).

In an embodiment 10, the composition is according to any one of embodiments 1 to 9, wherein the third component is a compound of formula (II′) as described elsewhere herein.

In an embodiment 11, the composition is according to any one of embodiments 1 to 9, wherein the third component is a compound of formula (IIa) as described elsewhere herein.

In an embodiment 12, the composition is according to any one of embodiments 1 to 9, wherein the third component is a compound of formula (IIa1).

In an embodiment 13, the composition is according to any one of embodiments 1 to 12, wherein the composition comprises a molar ratio of the first to second component as described elsewhere herein.

In an embodiment 14, the composition is according to any one of embodiments 1 to 13, wherein the composition comprises a molar ratio of the first to third component as described elsewhere herein.

In an embodiment 15, the composition is according to any one of embodiments 1 to 14, wherein the composition comprises a molar ratio of the third to second component as described elsewhere herein.

In an embodiment 16, the composition is according to any one of embodiments 1 to 15, wherein the composition comprises a viscosity as described elsewhere herein.

In an embodiment 17, the composition is according to any one of embodiments 1 to 16, wherein the composition comprises a polyol compound as described elsewhere herein.

In an embodiment 18, the composition is according to any one of embodiments 1 to 17, wherein the composition comprises an additive as described elsewhere herein.

In an embodiment 19, the composition is according to any one of embodiments 1 to 18, wherein the composition comprises a catalytically effective amount of a catalyst as described elsewhere herein.

In an embodiment 20, the composition is according to any one of embodiments 1 to 4, wherein the second component is water.

In an embodiment 21, the composition is according to any one of embodiments 10 to 20, provided that the second component is water.

More preferred and particular embodiments of the feature described in each one of embodiments 1 to 21 are as described elsewhere herein.

In a preferred embodiment, the composition of the first aspect of the invention comprises:
a first component that is ethylene carbonate; and
a second component that is water or pentaerythritol tetrakis(3-mercaptopropionate).

In a more preferred embodiment, the composition of the first aspect of the invention comprises:
a first component that is a compound of formula (Ib) as defined elsewhere herein, preferably a compound of formula (Ia) as defined elsewhere herein; more preferably, it is ethylene carbonate; and
a second component that is water or a compound A2 that is a compound of formula C(H)ₓ(-Q-SH)_{y} wherein each Q is independently a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10; y is an integer from 2 to 4 and x is an integer from 0 to 2, such that the sum of x and y is equal to 4;
preferably, A2 is a compound of formula (III)

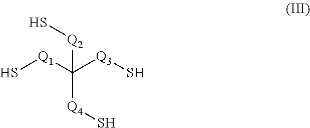

wherein each one of Q₁, Q₂, Q₃ and Q₄ is independently a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10;
or of formula CH₂(Q₁SH)(Q₂SH) wherein each one of Q₁ and Q₂ is independently a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10 more preferably, A2 is pentaerythritol tetrakis(3-mercaptopropionate) or 3,6-dioxa-1,8-octanedithiol pentaerythritol tetrakis(3-mercaptopropionate),
   wherein the molar amount ratio of thiol groups or water hydroxyl groups in the second component to the first component is from 1.0:3.0 to 1.0:0.8; preferably of 0.8:1.0 to 1.0:0.8.

In a preferred embodiment, the composition of the first aspect of the invention comprises:
a first component that is a compound of formula (Ib) as defined elsewhere herein, preferably a compound of formula (Ia) as defined elsewhere herein; more preferably, it is ethylene carbonate; and
a second component that is water or a compound A2 that is a compound of formula C(H)ₓ(-Q-SH)_{y} wherein each Q is independently a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10; y is an integer from 2 to 4 and x is an integer from 0 to 2, such that the sum of x and y is equal to 4;
preferably, A2 is a compound of formula (III)

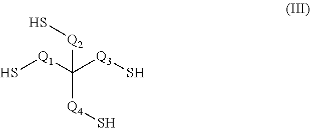

wherein each one of Q₁, Q₂, Q₃ and Q₄ is independently a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10;
   or of formula CH₂(Q₁SH)(Q₂SH) wherein each one of Q₁ and Q₂ is independently a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10
more preferably, A2 is pentaerythritol tetrakis(3-mercaptopropionate) or 3,6-dioxa-1,8-octanedithiol pentaerythritol tetrakis(3-mercaptopropionate),
   a third component that is a compound A3 of formula (IIa)

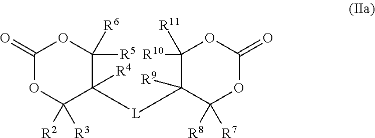

wherein each one of R², R³, R⁴, R⁵, R⁶, R⁷, R⁸, R⁹, R¹⁰ and R¹¹ is independently selected from the group consisting of hydrogen, halo, (C₁-C₆)alkyl, (C₂-C₆)alkenyl and (C₃-C₈)cycloalkyl; and
L is a diradical deriving from a group selected from the group consisting of (C₁-C₆)alkyl, (C₁-C₆)alkyloxy, (C₁-C₆)alkylamino, (C₁-C₆)alkyloxycarbonyl, (C₁-C₆)alkylaminocarbonyl, (C₁-C₆)alkylcarbonylamino, (C₁-C₆)alkylcarbonyloxy, (C₁-C₆)alkylthio, (C₂-C₆)alkenyl, a group of formula (C₁-C₆)alkyl-O—(C₁-C₆)alkyl, a radical of formula (C₁-C₆)alkyl-S—(C₁-C₆)alkyl, a group of formula (C₁-C₆)alkyl-NR¹²—(C₁-C₆)alkyl wherein R¹² is hydrogen or (C₁-C₆)alkyl, a group of formula (C₁-C₆)alkyl-CONR¹²—(C₁-C₆)alkyl wherein R¹² is hydrogen or (C₁-C₆)alkyl, a group of formula (C₁-C₆)alkyl-NR¹²CO—(C₁-C₆)alkyl wherein R¹² is hydrogen or (C₁-C₆)alkyl, a group of formula (C₁-C₆)alkyl-OCO—(C₁-C₆)alkyl, a group of formula (C₁-C₆)alkyl-COO—(C₁-C₆)alkyl, a group of formula (C₁-C₆)alkyl-(O—(C₁-C₆)alkyl)ₙ-O wherein n is an integer of from 1 to 10, a group of formula G, a group of formula (C₁-C₆)alkyl-G, a group of formula (C₁-C₆)alkyl-G-(C₁-C₆)alkyl, wherein G is a ring system comprising from 1 to 3 rings;
preferably wherein A3 is a compound of formula (IIa) wherein each one of R², R³, R⁴, R⁵, R⁶, R⁷, R⁸, R⁹, R¹⁰ and R¹¹ is independently selected from the group consisting of hydrogen, (C₁-C₆)alkyl, and (C₃-C₈)cycloalkyl and L is a diradical deriving from a group selected from the group consisting of (C₁-C₆)alkyl, (C₁-C₆)alkyloxy, (C₁-C₆)alkyloxycarbonyl, (C₁-C₆)alkylcarbonyloxy, a group of formula (C₁-C₆)alkyl-O—(C₁-C₆)alkyl, a group of formula (C₁-C₆)alkyl-OCO—(C₁-C₆)alkyl, and a group of formula (C₁-C₆)alkyl-COO—(C₁-C₆)alkyl;
more preferably wherein A3 is 5,5′-(oxybis(methylene))bis(5-ethyl-1,3-dioxan-2-one) of formula (IIa1)

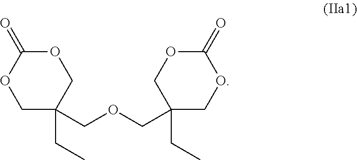 [SMILES: CCC1(COCC2(CC)COC(=O)OC2)COC(=O)OC1]

In a preferred embodiment, the composition of the first aspect of the invention comprises:
a first component that is ethylene carbonate;
a second component that is water or pentaerythritol tetrakis(3-mercaptopropionate) or 3,6-dioxa-1,8-octanedithiol; and
a third component that is 5,5′-(oxybis(methylene))bis(5-ethyl-1,3-dioxan-2-one) of formula (IIa1)

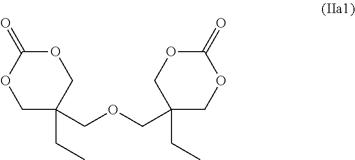 [SMILES: CCC1(COCC2(CC)COC(=O)OC2)COC(=O)OC1]

In a preferred embodiment, the composition of the first aspect of the invention comprises:
a first component that is ethylene carbonate;
a second component that is water or pentaerythritol tetrakis(3-mercaptopropionate) or 3,6-dioxa-1,8-octanedithiol; and
a third component that is 5,5′-(oxybis(methylene))bis(5-ethyl-1,3-dioxan-2-one) of formula (IIa1) as defined above;
   wherein the molar amount ratio of thiol groups or water hydroxyl groups in the second component to ethylene carbonate is from 1.0:3.0 to 1.0:0.8.

In a preferred embodiment, the composition of the first aspect of the invention comprises:
a first component that is ethylene carbonate;
a second component that is water or pentaerythritol tetrakis(3-mercaptopropionate) or 3,6-dioxa-1,8-octanedithiol; and
a third component that is 5,5′-(oxybis(methylene))bis(5-ethyl-1,3-dioxan-2-one) of formula (IIa1) as defined above;
   wherein the ratio of the molar amount of compound 5,5′-(oxybis(methylene))bis(5-ethyl-1,3-dioxan-2-one) to the molar amount of ethylene carbonate is from 0.8:1.0 and 1.0:0.8, and the molar amount ratio of thiol groups or water hydroxyl groups in the second component to ethylene carbonate is from 1.0:3.0 to 1.0:0.8.

In a preferred embodiment, the composition of the first aspect of the invention comprises:
a first component that is ethylene carbonate;
a second component that is water or pentaerythritol tetrakis(3-mercaptopropionate) or 3,6-dioxa-1,8-octanedithiol; and
a third component that is 5,5′-(oxybis(methylene))bis(5-ethyl-1,3-dioxan-2-one) of formula (IIa1)

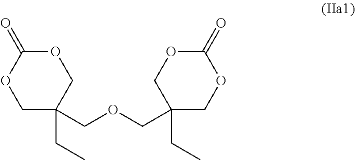 [SMILES: CCC1(COCC2(CC)COC(=O)OC2)COC(=O)OC1]

and a polyol compound selected from the group consisting of a polyester polyol, a polyether-polyester co-polymer polyol compound, aromatic polyols, a (C₁-C₆)alkane comprising at least one carbon atom attached to three or four radicals of formula —CH₂OR¹³ wherein each R¹³ group is independently selected from hydrogen, a polyethylene glycol chain and a polyester chain such as a polycaprolactone chain, and mixtures thereof; preferably, the polyol compound is selected from the group consisting of tetraether of pentaerythritol with polyethylene glycol, Poly(caprolactone) triol, Priplast™ 3162, Cardolite™ NX-9004, a polyether-polyester co-polymer polyol compound such as Sovermol® 750, aromatic polyols having an OH value of about 600 mg KOH per gram of polyol and mixtures thereof.

In a preferred embodiment, the composition of the first aspect of the invention comprises:
a first component that is ethylene carbonate;
a second component that is water or pentaerythritol tetrakis(3-mercaptopropionate) or 3,6-dioxa-1,8-octanedithiol; and
a third component that is 5,5′-(oxybis(methylene))bis(5-ethyl-1,3-dioxan-2-one) of formula (IIa1) as defined above;
and a polyol compound selected from the group consisting of a polyester polyol, a polyether-polyester co-polymer polyol compound, aromatic polyols, a (C₁-C₆)alkane comprising at least one carbon atom attached to three or four radicals of formula —CH₂OR¹³ wherein each R¹³ group is independently selected from hydrogen, a polyethylene glycol chain and a polyester chain such as a polycaprolactone chain, and mixtures thereof; preferably, the polyol compound is selected from the group consisting of tetraether of pentaerythritol with polyethylene glycol, Poly(caprolactone) triol, Priplast™ 3162, Cardolite™ NX-9004, a polyether-polyester co-polymer polyol compound such as Sovermol® 750, aromatic polyols having an OH value of about 600 mg KOH per gram of polyol and mixtures thereof;
wherein the ratio of the molar amount of compound 5,5′-(oxybis(methylene))bis(5-ethyl-1,3-dioxan-2-one) to the molar amount of ethylene carbonate is from 0.8:1.0 and 1.0:0.8, and the molar amount ratio of thiol groups or water hydroxyl groups in the second component to ethylene carbonate is from 1.0:3.0 to 1.0:0.8.

In a preferred embodiment, the composition of the first aspect of the invention comprises:
a first component that is ethylene carbonate;
a second component that is water or pentaerythritol tetrakis(3-mercaptopropionate) or 3,6-dioxa-1,8-octanedithiol; and
a third component that is 5,5′-(oxybis(methylene))bis(5-ethyl-1,3-dioxan-2-one) of formula (IIa1)

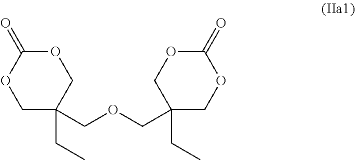 [SMILES: CCC1(COCC2(CC)COC(=O)OC2)COC(=O)OC1]

a polyol compound selected from the group consisting of a polyester polyol, a polyether-polyester co-polymer polyol compound, aromatic polyols, a (C₁-C₆)alkane comprising at least one carbon atom attached to three or four radicals of formula —CH₂OR¹³ wherein each R¹³ group is independently selected from hydrogen, a polyethylene glycol chain and a polyester chain such as a polycaprolactone chain, and mixtures thereof; preferably, the polyol compound is selected from the group consisting of tetraether of pentaerythritol with polyethylene glycol, Poly(caprolactone) triol, Priplast™ 3162, Cardolite™ NX-9004, a polyether-polyester co-polymer polyol compound such as Sovermol® 750, aromatic polyols having an OH value of about 600 mg KOH per gram of polyol and mixtures thereof;
and a catalytically effective amount of a catalyst suitable for the reaction of water or a hydroxyl or a thiol group of the compound A2 with a secondary or tertiary carbon atom of the moiety of formula (I) in the compound A1 that is 1,8-diazabicyclo[5.4.0]undec-7-ene.

In a preferred embodiment, the composition of the first aspect of the invention comprises:
a first component that is ethylene carbonate;
a second component that is water or pentaerythritol tetrakis(3-mercaptopropionate) or 3,6-dioxa-1,8-octanedithiol; and
a third component that is 5,5′-(oxybis(methylene))bis(5-ethyl-1,3-dioxan-2-one) of formula (IIa1) as defined above;
a polyol compound selected from the group consisting of a polyester polyol, polyether-polyester co-polymer polyol compound, aromatic polyols, a (C₁-C₆)alkane comprising at least one carbon atom attached to three or four radicals of formula —CH₂OR¹³ wherein each R¹³ group is independently selected from hydrogen, a polyethylene glycol chain and a polyester chain such as a polycaprolactone chain, and mixtures thereof; preferably, the polyol compound is selected from the group consisting of tetraether of pentaerythritol with polyethylene glycol, Poly(caprolactone) triol, Priplast™ 3162, Cardolite™ NX-9004, a polyether-polyester co-polymer polyol compound such as Sovermol® 750, aromatic polyols having an OH value of about 600 mg KOH per gram of polyol and mixtures thereof;
and a catalytically effective amount of a catalyst suitable for the reaction of water or a hydroxyl or a thiol group of the compound A2 with an aliphatic carbon atom of the moiety of formula (I) in the compound A1 that is 1,8-diazabicyclo[5.4.0]undec-7-ene; wherein the ratio of the molar amount of compound 5,5′-(oxybis(methylene))bis(5-ethyl-1,3-dioxan-2-one) to the molar amount of ethylene carbonate is from 0.8:1.0 and 1.0:0.8, and the molar amount ratio of thiol groups or water hydroxyl groups in the second component to ethylene carbonate is from 1.0:3.0 to 1.0:0.8.

In a preferred embodiment, the composition of the first aspect of the invention comprises:
a first component that is ethylene carbonate;
a second component that is 3,6-Dioxa-1,8-octanedithiol or pentaerythritol tetrakis(3-mercaptopropionate);
a third component that is 5,5′-(oxybis(methylene))bis(5-ethyl-1,3-dioxan-2-one) of formula (IIa1) as defined above;
and a catalytically effective amount of a catalyst suitable for the reaction of a thiol group of the compound A2 with an aliphatic carbon atom of the moiety of formula (I) in the compound A1 that is 1,8-diazabicyclo[5.4.0]undec-7-ene;
   wherein the molar amount ratio of compound A2 thiol groups or water hydroxyl groups to compound A1 moieties of formula (I) from 1.0:3.0 to 1.0:0.8 and/or the molar amount ratio of compound A3 moieties of formula (II) to compound A2 thiol groups is between 1.5:1 and 5:1, preferably between 1.5:1 and 2.5:1.

In an embodiment, in any of the herein described embodiments, the second component is water.

In another embodiment, in any of the herein described embodiments, the second component is compound A2 as defined in any embodiment described herein, preferably it is pentaerythritol tetrakis(3-mercaptopropionate) or 3,6-Dioxa-1,8-octanedithiol.

As defined above, a second aspect of the invention relates to a process for the preparation of a polycarbonate foam, said process comprising the steps of:
(i) providing a composition comprising a compound A1, water or a compound A2 and a compound A3, said compounds being as defined in the first aspect of the invention,
(ii) optionally, heating the composition resulting from (i) so as to provide a liquid composition,
(iii) adding a catalytically effective amount of a catalyst as defined in the first aspect of the invention to the composition resulting from (i) or (ii), and
(iv) heating the composition resulting from step (iii) so as to produce a polycarbonate foam.

In a preferred embodiment of the second aspect of the invention, the compounds A1, A2, A3 and the catalyst are each as defined in any particular or preferred embodiment of the first aspect of the invention defined above.

In a preferred embodiment of the second aspect of the invention, the relative amounts of the compound A1 to water or the compound A2 is as defined in any particular or preferred embodiment of the first aspect of the invention defined above.

In a more preferred embodiment of the second aspect of the invention, the relative amounts of the compound A1 to the compound A3 is as defined in any particular or preferred embodiment of the first aspect of the invention defined above.

In preferred embodiment of the second aspect of the invention, the composition provided in step (i) further comprises a polyol compound as defined in any particular or preferred embodiment of the first aspect of the invention defined above. The amount of said polyol compound is preferably as defined in any particular or preferred embodiment of the first aspect of the invention defined above.

In preferred embodiment of the second aspect of the invention, the composition provided in step (i) further comprises an additive as defined in any particular or preferred embodiment of the first aspect of the invention defined above.

In a preferred embodiment, the process of the second aspect of the invention comprises the previous step, prior to step (iii), of unmasking the masked thiol precursors comprised in the second component. Methods for this step are known in the art and will become apparent to the skilled person. These include, among others, the reduction of a disulfide to thiols.

In a preferred embodiment of the second aspect of the invention, step (ii) is carried out.

In a more preferred embodiment, step (ii) is carried out at a temperature sufficiently high for all or part, preferably all, of the components of the composition provided in step (i) to melt. Such temperature may by of between 60° C. and 100° C., and is preferably of about 70° C.

In a more preferred embodiment of the second aspect of the invention, the catalyst of step (iii) is as defined in any particular or preferred embodiment of the first aspect of the invention defined above and is preferably is 1,8-diazabicyclo[5.4.0]undec-7-ene.

In a more preferred embodiment of the second aspect of the invention, step (iv) is carried out at a temperature sufficiently high for initiating the reaction between the first and the second component. Such temperature may by of between 60° C. and 100° C., and is preferably of between 70° C. and 80° C. The initiation of the reaction can be detected by the evolution of carbon dioxide.

As defined above, a third aspect of the invention relates to a polycarbonate foam obtainable by the process of the second aspect of the invention. Preferred and particular embodiments of the first and second aspects of the invention defining, among others, the components and amounts thereof of the composition and conditions of the process likewise represent preferred embodiments of the third aspect of the invention.

The fourth aspect of the invention relates to a kit of parts suitable for forming a polycarbonate foam. Said kit comprises a plurality of parts, the kit comprising the compound A1, water or the compound A2 and the compound A3, said compounds being as defined in the first aspect of the invention and a catalytically effective amount of a catalyst as defined in in the first aspect of the invention, whereby the catalyst is provided in a different part than water or the compound A2 or the compound A1.

In a preferred embodiment of the fourth aspect of the invention, the relative amounts of the compound A1 to water or the compound A2 is as defined in any particular or preferred embodiment of the first aspect of the invention defined above.

In a more preferred embodiment of the fourth aspect of the invention, the relative amounts of the compound A1 to the compound A3 is as defined in any particular or preferred embodiment of the first aspect of the invention defined above.

In preferred embodiment of the fourth aspect of the invention, the kit further comprises a polyol compound as defined in any particular or preferred embodiment of the first aspect of the invention defined above. The amount of said polyol compound is preferably as defined in any particular or preferred embodiment of the first aspect of the invention defined above.

In preferred embodiment of the fourth aspect of the invention, the kit further comprises an additive as defined in any particular or preferred embodiment of the first aspect of the invention defined above.

As the reaction between the compound A1 and water or the compound A2 in the presence of the catalyst generates carbon dioxide as blowing agent, it is contemplated and preferred that the kit comprises said components in separated parts.

Similarly, it is also contemplated that the kit comprises any polyol compound comprised in the kit in a separated part than the third component (compound A3).

In a preferred embodiment of the fourth aspect of the invention, the kit comprises a part comprising the first and third components, and a further part comprising the second component and, optionally, the polyol compound.

The kit may further comprise means for mixing the content of the parts forming the kit and provide a liquid mixture, e.g. by heating.

As defined above, the fifth aspect of the invention relates to a polycarbonate foam, preferably obtainable as described above, comprising in its molecular formula at least one moiety of formula (IV)

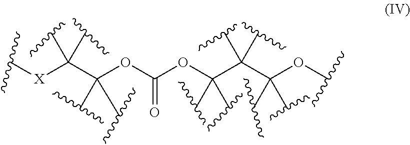

wherein X is S or O and wherein each wavy line represents the position to which the moiety of formula (IV) is attached to the remainder of the polycarbonate foam.

As will be obvious to the skilled person, the moiety of formula (IV) is formed by reaction of the second component with the first component as described elsewhere herein, forming a compound comprising a moiety of formula (V)

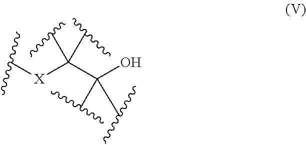

said moiety reacting consequently with at least one moiety of formula (II) of the third component to form a compound comprising a moiety of formula (IV).

As will also be obvious to the skilled person, atom X in the moieties of formula (IV) and (V) corresponds to the O atom in water or to an S atom of any of the thiol groups comprised in compound A2 as described elsewhere herein.

Thus, when the first component is ethyl carbonate and the second component is 5,5′-(oxybis(methylene))bis(5-ethyl-1,3-dioxan-2-one) of formula (IIa1) as defined above, the moiety of formula (IV) is preferably a moiety having the formula (IVa) (IVa)

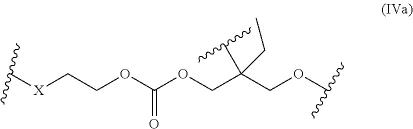

wherein each wavy line represents the position to which the moiety of formula (IVa) is attached to the remainder of the polycarbonate foam.

In a preferred embodiment, the polycarbonate foam comprises in its molecular formula at least 10 moieties, more preferably at least 100 moieties, of formula (IV).

As defined above, a sixth aspect of the invention relates to a process comprising the steps of:
(i) providing a polycarbonate foam according to the third or fifth aspect of the invention;
(ii) subjecting the polycarbonate foam of step (i) to silanization, preferably by contacting the polycarbonate foam of step (i) with a compound of formula FG-Z-SiLG₃ wherein each LG is a group independently, preferably simultaneously, selected from halo, preferably chloro, and (C₁-C₆)alkyloxy;
Z is a diradical deriving from a (C₁-C₃₀)alkyl group; and
FG is selected from the group consisting of hydrogen, SH, vinyl, P(O)(OR¹⁴)₂, and ⁺NR¹⁵R¹⁶R¹⁷R¹⁸ wherein each one of R¹⁴, R¹⁵, R¹⁶, R¹⁷ and R¹⁸ is independently selected from (C₁-C₆)alkyl groups.

In a preferred embodiment of the sixth aspect of the invention, the polycarbonate foam of step (i) is as defined in any one of the embodiments described herein for the third aspect of the invention.

In another preferred embodiment of the sixth aspect of the invention, the polycarbonate foam of step (i) is as defined in any one of the embodiments described herein for the fifth aspect of the invention.

In a preferred embodiment of the sixth aspect of the invention, the polycarbonate foam of step (i) is one wherein the polycarbonate foam of step (i) is obtainable by the process which comprises:
(i) providing a composition comprising:
   (a) a first component that is a compound A1 comprising in its molecular formula one or more moieties of formula (I)

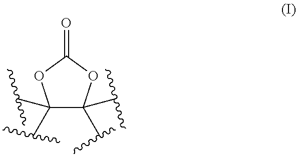 [SMILES: *C1(*)OC(=O)OC1(*)*]

wherein each wavy line represents the position to which the moiety of formula (I) is attached to the remainder of the compound of formula A1, provided that at least one of said attachments is to a hydrogen atom; preferably said first component is ethyl carbonate:
(b) a second component that is water or a compound A2 comprising in its molecular formula a plurality of thiol groups or masked precursors thereof; preferably, said second component is selected from water and pentaerythritol tetrakis(3-mercaptopropionate);
(c) a third component that is a compound A3 comprising in its molecular formula one or more moieties of formula (II)

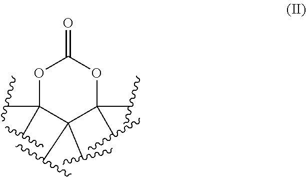 [SMILES: *C1(*)OC(=O)OC(*)(*)C1(*)*]

wherein each wavy line represents the position to which the moiety of formula (II) is attached to the remainder of the compound of formula A3; said third component being preferably 5,5′-(oxybis(methylene))bis(5-ethyl-1,3-dioxan-2-one);
(d) a polyol compound that is selected from the group consisting of a polyether-polyester co-polymer polyol compound, aromatic polyols, Priplast™ 3162, Cardolite™ NX-9004, a (C₁-C₆)alkane comprising at least one carbon atom attached to three or four radicals of formula —CH₂OR¹³ wherein each R¹³ group is independently selected from hydrogen, a polyethylene glycol chain and a polyester chain such as a polycaprolactone chain, and mixtures thereof; preferably, the polyol compound is selected from the group consisting of tetraether of pentaerythritol with polyethylene glycol, Poly(caprolactone) triol, Priplast™ 3162, Cardolite™ NX-9004, a polyether-polyester co-polymer polyol compound such as Sovermol® 750, aromatic polyols having an OH value of about 600 mg KOH per gram of polyol and mixtures thereof, and
(e) optionally, a catalytically effective amount of a catalyst suitable for the reaction of water or a thiol group of the compound A2 with an aliphatic carbon atom of the moiety of formula (I) in the compound A1; said catalyst being preferably DBU;
(ii) optionally, heating the composition resulting from (i) so as to provide a liquid composition,
(iii) add a catalytically effective amount of a catalyst as defined in any one of the embodiments of the first aspect of the invention to the composition resulting from (i) or (ii), and
(iv) heating the composition provided in step (iii) so as to produce a polycarbonate foam.

In another preferred embodiment of the sixth aspect of the invention, LG is selected from the group consisting of chloro, methyl and ethyl.

In another more preferred embodiment of the sixth aspect of the invention, LG is a chloro group.

As mentioned above, FG is selected from the group consisting of hydrogen, SH, vinyl, P(O)(OR¹⁴)₂, and +NR¹⁵R¹⁶R¹⁷R¹⁸ wherein each one of R¹⁴, R¹⁵, R¹⁶, R¹⁷ and R¹⁸ is independently selected from (C₁-C₆)alkyl groups. When FG is hydrogen, the resulting polycarbonate foam is particularly hydrophobic, particularly when Z is a diradical deriving from a (C₃-C₃₀)alkyl group, since its surface is functionalized with a plurality of long hydrocarbon chains. When FG is thiol or vinyl, the resulting polycarbonate foam is suitable for cross-linking via thiol-ene chemistry with further compounds comprising thiol or vinyl groups. When FG is a group of formula P(O)(OR¹⁴)₂, being R¹⁴ as defined above, the resulting polycarbonate foam is less flammable than the corresponding pristine material, since the P(O)(OR¹⁴)₂ group is known in the art for being a flame-retardant functional group. Similarly, when FG is a group of formula ⁺NR¹⁵R¹⁶R¹⁷R¹⁸ wherein each one of R¹⁵, R¹⁶, R¹⁷ and R¹⁸ is as defined above, the resulting polycarbonate foam presents antibacterial properties, since quaternary ammonium groups are known in the art for their antibacterial properties.

In a preferred embodiment of the sixth aspect of the invention, FG is hydrogen.

In an even more preferred embodiment of the sixth aspect of the invention, FG is hydrogen and Z is a diradical deriving from a (C₃-C₃₀)alkyl group, such as an octadecyl group.

In an even more preferred embodiment of the sixth aspect of the invention, the compound of formula FG-Z-SiLG₃ is octadecyltrichlorosilane.

A seventh aspect of the invention relates to a polycarbonate foam obtainable by the process of the sixth aspect of the invention.

In preferred embodiments, the seventh aspect of the invention relates to a polycarbonate foam obtainable by the process as defined in any of the preferred and particular embodiments of the sixth aspect of the invention.

In specific embodiments of the sixth and seventh aspects, in particular when FG is hydrogen, the inventors have found that the produced polycarbonate foam is highly hydrophobic and exhibits strong affinity for organic phases and/or oils. Such material is thus useful in the removal of an organic phase and/or oils from mixtures of these components with an aqueous phase. Thus, an eight aspect of the invention relates to a method for removing an organic phase and/or an oil from a mixture of an aqueous phase with an organic phase and/or an oil comprising the steps of:
(i) contacting a polycarbonate foam obtainable by the process of the seventh aspect of the invention when FG is hydrogen with said organic phase and/or oil to produce a foam soaked with said organic phase and/or oil; and
(ii) separating said foam soaked with said organic phase and/or oil from the aqueous phase by means of solid-liquid separation techniques, such as filtration or decantation.

Throughout the description and claims the word “comprises” and variations of the word, are not intended to exclude other technical features, additives, components or steps. Furthermore, the word “comprise” encompasses the cases of “consist of” and “consists essentially of”. Additional objects, advantages and features of the invention will become apparent to those skilled in the art upon examination of the description or may be learned by practice of the invention. The following examples are provided by way of illustration, and they are not intended to be limiting of the present invention.

### EXAMPLES

### Materials

Ethylene carbonate (98%, A1A), pentaerythritol tetrakis(3-mercaptopropionate) (>95%, A2A), 3,6-dioxa-1,8-octanedithiol and polycaprolactone triol, average Mn~900 (AI1), Pentaerythritol ethoxylate (15/4 EO/OH), average Mn~797, di(trimethylolpropane) (97%, Di-TMP) were used as received from Sigma-Aldrich. 1,8-Diazabicyclo[5.4.0]undec-7-ene (98%, DBU) was used as received from Alfa Aesar. TEGOMER E-Si 2330 was supplied by Quimidroga S.A. Laponite S482 was supplied by Comindex S.A. Sovermol® 750, a bio-based polyol with an OH value of 200-230 mg KOH g⁻¹, was purchased from BASF. Cardolite NX-9004 was purchased from Cardolite. Priplast 3162 was purchased from Cargill.

5,5′-(oxybis(methylene))bis(5-ethyl-1,3-dioxan-2-one) (A2A) was synthesized according to the procedure previously reported by Yang, and co-workers in “Biodegradable Cross-linked Poly(trimethylene carbonate) Networks for Implant Applications: Synthesis and Properties”. Polymer 2013, 54, 2668-2675, page 2669 paragraph 2.2, incorporated herein by reference. ¹H-NMR (300 MHz, CDCl₃) δ 4.29 (d, J=10.1 Hz, 4H, —CH₂OCOOCH₂—), 4.17 (d, J=10.5 Hz, 4H, —CH₂COOCH₂), 3.50 (s, 4H, —CH₂OCH₂—), 1.50 (q, J=7.5 Hz, 4H, —CH₃CH₂C—), 0.91 (t, J=7.6 Hz, 6H, CH₃CH₂C—).

Table 1 below summarizes the reactants used in the Examples below.

TABLE 1

| Entry | Name | Molecular formula/Information |
|---|---|---|
| A3A | 5,5′-(oxybis(methylene))bis(5- ethyl-1,3-dioxan-2-one) | 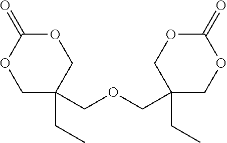 [SMILES: CCC1(COCC2(CC)COC(=O)OC2)COC(=O)OC1] |
| A1A | Ethylene carbonate | 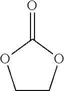 |
| A2A | pentaerythritol tetrakis(3- mercaptopropionate) | |
| Al1 | Poly(caprolactone) triol | 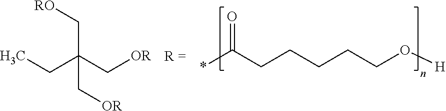 |
| A12 | tetraether of pentaerythritol | Pentaerythritol ethoxylate (15/4 EO/OH) |
| | with polyethylene glycol | with average Mn of about 797 g · mol − 1 |
| | | CAS number 30599-15-6 |
| AI3 | polyether-polyester co-polymer | |
| | polyol Sovermol ® 750 | |
| A15 | Sovermol 805 ® | |
| | branched polyether/-ester bio- | |
| | based polyol | |
| | Properties: Hydroxy number: | |
| | 160-185 mg KOH · g − 1 | |
| | Molecular weight: 1155 g · mol − 1 | |
| | Functionality: 3.5 | |
| | Viscosity: 2.800-4000 mPa · s | |
| A16 | Priplast ™ 3162 Hydroxyl Number: 100-120 mg KOH/g and Viscosity (20°) 1080 mPa · s | 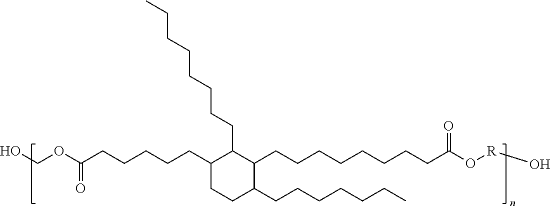 |
| A17 | Cardolite NX-9004 Hydroxyl Number: 160-210 mg KOH/g and Viscosity (25° C.): 4500-6000 mPa · s | 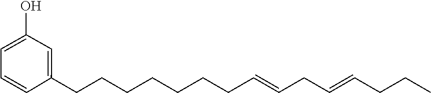 [SMILES: CCC/C=C/C/C=C/CCCCCCCc1cccc(O)c1] |
| Add1 | Laponite S482 | |
| Add2 | Di(trimethylolpropane) | |
| Add 3 | Tegomer E-Si 2330 | |

### Characterizations

¹H NMR analyses were performed on a Bruker Avance DPX spectrometer at 300 MHz. Chemical shifts are shown as relative to the residual non-deuterated species of the used solvent: chloroform-d (CDCl₃: δ(¹H)=7.26 ppm), dimethylsulfoxide-d₆ ((CD₃)₂SO: δ(¹H)=2.50 ppm).

FTIR measurements were carried out on a Nicolet IS20 spectrometer (Thermo Scientific) equipped with a diamond attenuated transmission reflectance (ATR) device. 32 scans were recorded for each sample over the range of 500-4000 cm⁻¹ with a normal resolution of 4 cm⁻¹.

The cell size and morphology of the foams was determined with a scanning electron microscope (SEM, Hitachi™ 3030) by averaging the diameter of 100 cells of 6 SEM images (100 measures for each sample). Cell-faces area (A_{c}) and cell-face holes (Aₕ) were measured by ImageJ software. For each sample, the 30 cell areas and holes on them (if any) were calculated using the elliptical selection tool. The holes on cells area ratio were then computed for each cell and averaged for each sample to get the final value of Aₕ/A_{c}. Only holes with clear dark pixels were considered.

### Example 1: Preparation of Polycarbonate Foams Using Polythiol Compounds

General Procedure 1: To a 25 mL PTFE beaker charged with pentaerythritol tetrakis(3-mercaptopropionate) A2A (0.808 g, 1.654 mmol) and an alcohol compound that is one of A11, A12, A13, A16 or A17 (amount as indicated in Table 2) were added di(trimethylolpropane carbonate) A3A (2 g, 6,616 mmol) and ethylene carbonate A1A (0.583 g, 6.616 mmol), whereby compounds A2A, A11 to A13, A3A and A1A are as defined in Table 1. The mixture was heated to 70° C. to ensure the complete melting of all the reactants, and then 1,8-diazabicyclo[5.4.0]undec-7-ene (DBU, 0.0987 mL, 0.662 mmol, 5 mol % to the carbonate moieties) was added to this mixture. After mechanical mixing for 10 minutes, the reactive formulation was cured in an oven for 45 minutes at 70° C.

Table 2 summarizes the prepared materials using general procedure 1 employing as alcohol compound one alcohol compound as disclosed in Table 1 and whereby some additives are optionally added in the amount indicated in Table 2. Table 2 also provides a reference to a figure for each of the prepared polycarbonate foam materials, together with the properties (density and morphology) of the prepared foam material.

TABLE 2

| | Alcohol | | | | | |
|---|---|---|---|---|---|---|
| | compound | | | | Cell size | |
| Entry | (amount) | Additive (amount) | Figure | ρₐ [g · cm⁻³] | [mm] | Aₕ/A_{c} |
| 1 | Al1 (1.105 | None | 1 | 0.180 ± 0.005 | n.d. | n.d. |
| | mmol) | | | | | |
| 2 | Al1 (1.105 | Laponite (1.5 | 2 | 0.200 ± 0.005 | 0.70 ± 0.29 | 10.6 |
| | mmol) | weight % of starting | | | | |
| | | composition) | | | | |
| 3 | Al1 (1.105 | Di(trimethylolpropane) | 3 | 0.278 ± 0.007 | 0.98 ± 0.37 | 9.1 |
| | mmol) | (0.125 | | | | |
| | | equivalent related | | | | |
| | | to A3A) | | | | |
| 4 | Al3 (1.092 | Tegomer E-Si ® | 4 | 0.230 ± 0.005 | 0.33 ± 0.10 | 0.113 |
| | mmol) | (0.1 equivalent | | | | |
| | | compared to A1A + | | | | |
| | | A3A) | | | | |
| 5 | Al3 (1.105 | Laponite (1.5 | 5 | 0.293 ± 0.007 | 0.73 ± 0.26 | 0.085 |
| | mmol) | weight % of starting | | | | |
| | | composition) | | | | |
| 6 | Al2 (0.827 | Tegomer E-Si ® | 6 | n.d. | n.d. | n.d. |
| | mmol) | (0.1 equivalent | | | | |
| | | compared to A1A + | | | | |
| | | A3A) | | | | |
| 8 | Al5 (1.892 | None | 7 | — | — | — |
| | mmol) | | | | | |
| 9 | Al3 (1.105 | None | 11 | 0.300 ± 0.013 | n.d. | n.d. |
| | mmol) | | | | | |
| 10 | Al6 (1.65 | None | 14 | 0.247 ± 0.012 | 2.22 ± 0.61 | — |
| | mmol) | | | | | |
| 11 | Al7 (1.65 | None | 15 | 0.173 ± 0.006 | — | — |
| | mmol) | | | | | |
| 12* | Al7 (1.65 | None | 16 | 0.213 ± 0.011 | 0.65 ± 0.27 | — |
| | mmol) | | | | | |
| 13* | Al7 (1.65 | Tegomer E-Si | 17 | 0.175 ± 0.012 | 0.30 ± 0.09 | — |
| | mmol) | | | | | |

*DBU content was of 3.125 mol % to the carbonate moieties instead of 5 mol % to the carbonate moieties
n.d.: not determined

### Example 2: Preparation of Polycarbonate Foams Using Water

General Procedure 2: To a 25 mL PTFE beaker charged with water (6.616 mmol) and an alcohol compound that is A11, A13; A16 or A17 (amount as indicated in Table 3) were added di(trimethylolpropane carbonate) A3A (2 g, 6,616 mmol) and ethylene carbonate A1A (0.583 g, 6.616 mmol), whereby compounds A11, A13, A16, A17, A3A and A1A are as defined in Table 1. The mixture was heated to 70° C. to ensure the complete melting of all the reactants, and then 1,8-diazabicyclo[5.4.0]undec-7-ene (DBU, 0.0987 mL, 0.662 mmol, 5 mol % to the carbonate moieties) was added to this mixture. After mechanical mixing for 10 minutes, the reactive formulation was cured in an oven for 60 minutes at 80° C.

Table 3 summarizes the prepared materials using general procedure 2 employing as alcohol compound one alcohol compound as disclosed in Table 1 and whereby some additives are optionally added in the amount indicated in Table 3. Table 3 also provides a reference to a figure for each of the prepared polycarbonate foam materials, together with the properties (density and morphology) of the prepared foam material.

TABLE 3

| Alcohol | | | | Cell | |
|---|---|---|---|---|---|
| compound | Additive | | | size | |
| (amount) | (amount) | FIG. | ρₐ [g · cm⁻³] | [mm] | Aₕ/A_{c} |
| Al1 (1.105 | None | 8 | 0.514 ± | 0.35 ± | 9.5. |
| mmol) | | | 0.010 | 0.10 | |
| Al1 (1.105 | Laponite (1.5 | 9 | 0.502 ± | 0.45 ± | 18.7 |
| mmol) | weight % of | | 0.014 | 0.13 | |
| | starting | | | | |
| | composition) | | | | |
| Al3 (1.092 | none | 10 | 0.449 ± | 0.78 ± | 11.7 |
| mmol) | | | 0.013 | 0.23 | |
| Al6 (1.65 | None | 18 | 0.452 ± | 0.49 ± | — |
| mmol) | | | 0.007 | 0.22 | |
| Al7* (0.81 | None | 19 | 0.303 ± | — | — |
| mmol) | | | 0.006 | | |

*DBU content was of 3.125 mol % to the carbonate moieties instead of 5 mol % to the carbonate moieties

The results of Examples 1 and 2 show that the compositions according to the invention are suitable for the formation of polycarbonate foams with no need for an external blowing agent, such as carbon dioxide, said blowing agent being generated in situ during the polymerization reaction, triggered by the orthogonal reactivity of thiol groups and water towards cyclic carbonate of different size rings.

### Example 3: Preparation of Polycarbonate Foams in the Absence of Polyol Compounds

Foam materials were prepared using General Procedure 1 described above and employing compositions comprising the amounts of A2 and A3A (expressed in equivalents over A1A) indicated in Table 4, 5 mol % of DBU (with respect to A1A)

TABLE 4

| | | Amount of | | |
|---|---|---|---|---|
| | | A3A (in | Amount of A2 | |
| | | equiv. | (in equiv. | |
| Entry | Compound of formula A2 | vs A1A) | vs A1A) | FIG. |
| 1 | 3,6-Dioxa-1,8-octanedithiol | 1 | 0.5 ^{a} | 13-a |
| 2 | 3,6-Dioxa-1,8-octanedithiol | 0.5 | 0.5 ^{b} | 13-b |
| 3 | Pentaerythritol tetrakis(3- | 1 | 0.25 ^{a} | 13-c |
| | mercaptopropionate) | | | |
| 4 | Pentaerythritol tetrakis(3- | 0.5 | 0.25 ^{b} | 13-d |
| | mercaptopropionate) | | | |
| 5 | Pentaerythritol tetrakis(3- | 2 | 0.25 | 13-e |
| | mercaptopropionate) | | | |
| 6 | Pentaerythritol tetrakis(3- | 1.33 | 0.25 | |
| | mercaptopropionate) | | | |
| 7 | Pentaerythritol tetrakis(3- | 0.66 | 0.25 | 13-f |
| | mercaptopropionate) | | | |

^{a} the molar ratio of SH groups to moieties of formula (II) in A3A is 1:2;
^{b} the molar ratio of SH groups to moieties of formula (II) in A3A is 1:1

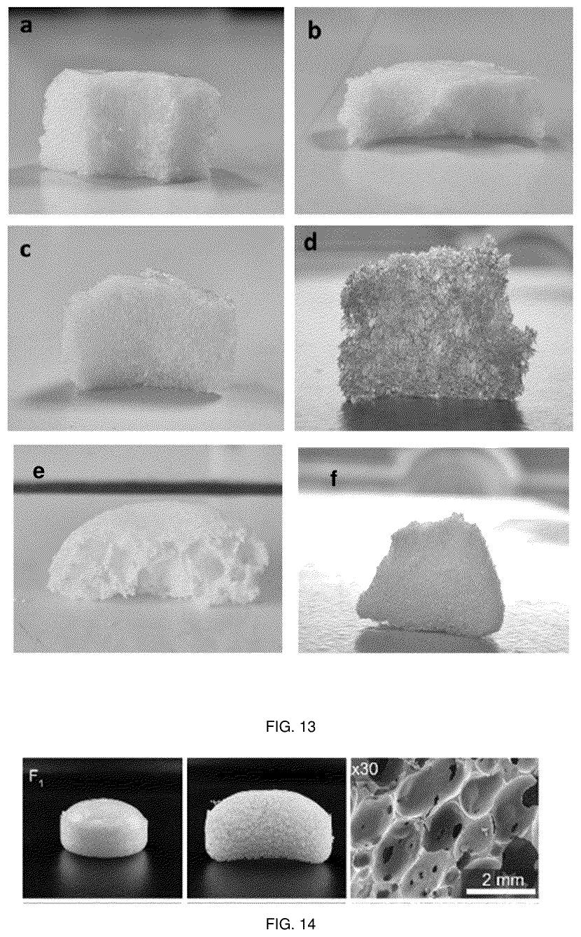

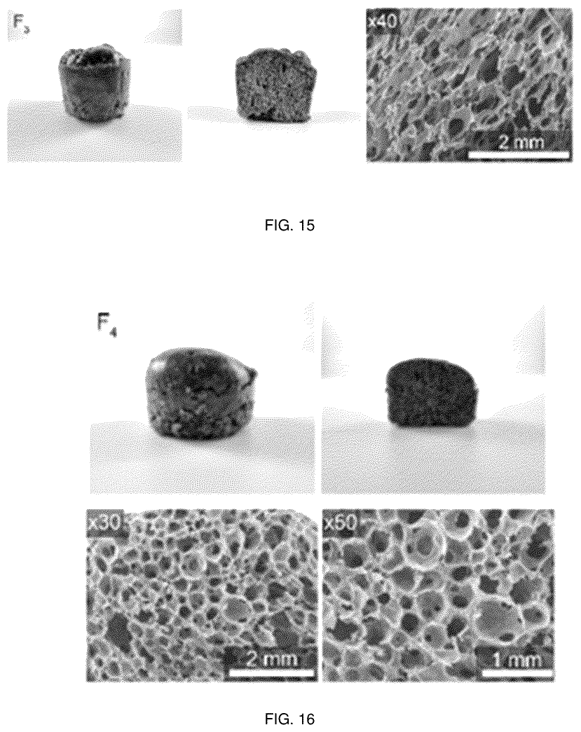

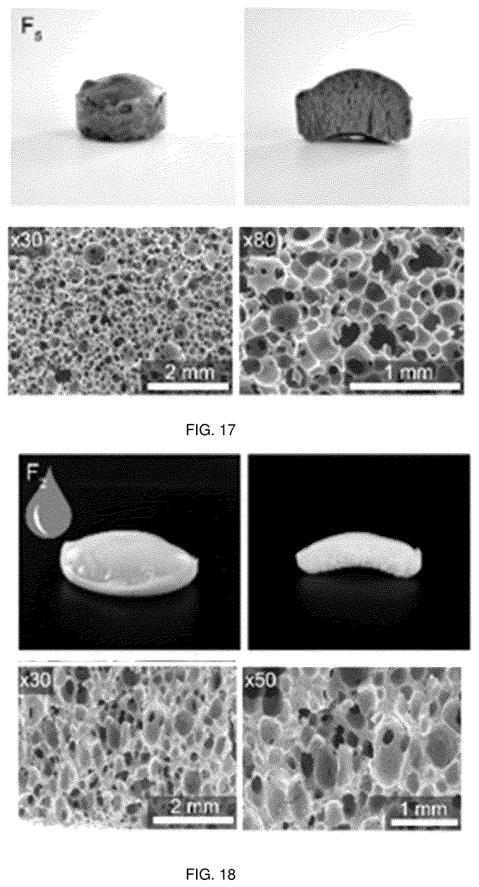

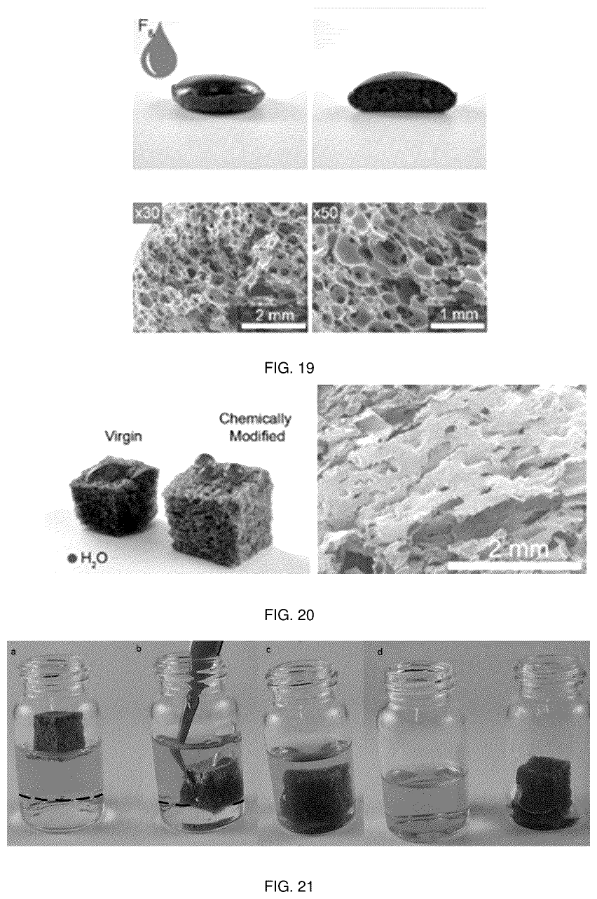

The results of FIG. 13 a-d show that polycarbonate foam materials are formed even when no polyol is present in the composition of the invention.

### Example 4: Rheological Measurements

### Procedures:

Rheology measurements (time sweep experiments) were carried out with a PHYSICA MCR501 Rheometer at 70° C. using 25 mm flat parallel plates at a frequency of 1 Hz, a strain of 1%. The studied compositions were homogeneized at 50° C. before adding the catalyst. After adding the catalyst, the sample was loaded into the rheometer pre-heated at 50° C. and the temperature was increased to 70° C.

Compression tests were carried out using an Anton Paar MCR702 instrument equipped with 25 mm plate-plate geometry. The foams (a cylindrical shape with a diameter of 10 mm height×10 mm diameter) were applied under compression mode with a strain rate of 10% per minute at 25° C. (preload force; 0.01 N).

Young Modulus, storage modulus and viscosity were determined following well-established procedures from the rheology measurements and compression tests: Such procedure for viscosity measurement is disclosed for instance in Mezger, T. G. The Rheology Handbook: 4th Edition; Vincentz Network, 2019, chapter 8.2.3, incorporated herein by reference. In particular, an isothermal oscillatory time sweep experiment was conducted at 70° C. The gap between the plates was kept constant (≈1.2-1.7 mm). Changes in the modulus (G′, G″), normal force (FN) exerted by rising foam on the upper plate, and complex viscosity (r*) were evaluated as a function of time, at a constant strain of 1% (within the linear regime) and a constant angular frequency ω of 1 rad/s.

Table 5 shows the compositions studied in this Example and report the measured value for Young Modulus, Storage modulus and viscosity measured at the gelling point.

| | Young | Storage | Viscosity at |
|---|---|---|---|
| | Modulus | modulus | 70° C. after 540 |
| Composition | (E) (kPa) | G′ (kPa) | seconds (Pa · s) |
| Example 1 | 0.24 | 52 | 140 |
| Table 2 | | | |
| entry 1 | | | |
| Example 1 | — | — | 354 |
| Table 2 | | | |
| entry 3 | | | |
| Example 3 | 1.06 | 148 | 340 |
| Table 4 | | | |
| entry 1 | | | |
| Example 3 | — | 36 | 37 |
| Table 4 | | | |
| entry 2 | | | |
| Example 3 | 0.83 | 107 | 255 |
| Table 4 | | | |
| entry 3 | | | |
| Example 3 | — | 23 | 26 |
| Table 4 | | | |
| entry 4 | | | |
| Example 3 | — | 878 | 39414 |
| Table 4 | | | |
| entry 5 | | | |
| Example 3 | — | 146 | 326 |
| Table 4 | | | |
| entry 6 | | | |
| Example 3 | — | 32 | 21 |
| Table 4 | | | |
| entry 7 | | | |

The gelation time of all compositions was evaluated at the point where G′ value starts being higher than the value of G″ as measured in rheological experiments.

### Example 5: Surface Functionalization of PC Foams

Foam of Entry 12 of Table 1 was immersed in a 30 mL hexane solution of n-octadecyltrichlorosilane (OTS) solution containing 100 mg of OTS. After immersion for 2 h, the foam was washed with methanol to remove the unreactive siloxane; finally, the silanized OTS@PC foam was dried at 60° C. for 1 h.

Table 6 shows the measured contact angle for the prepared materials:

TABLE 6

Contact angle (°)

| | | Before treatment | After treatment |
|---|---|---|---|
| Entry | Starting material | with OTS | with OTS |
| 1 | Entry 12 Table 2 | — | 129 |

The results of Table 6 show that polycarbonate foams treated with OTS exhibit a stronger hydrophobic character than untreated polycarbonate foams. These foams were found to repel aqueous phases, as shown in FIG. 20 and present high affinity with organic phases, such as dichloromethane. Inventors found that samples treated with OTS are suitable for removing organic solvents and oils from aqueous phases, e.g. by soaking the treated material in a mixture of water with said oil and/or organic phase. This is shown in FIG. 21.

1. A composition comprising:
(a) a first component that is a compound A1 comprising in its molecular formula one or more moieties of formula (I) 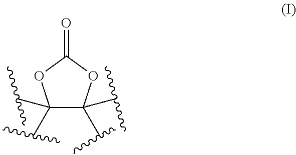 [SMILES: *C1(*)OC(=O)OC1(*)*]
wherein each wavy line represents the position to which the moiety of formula (I) is attached to the remainder of the compound of formula A1, provided that at least one of said attachments is to a hydrogen atom;
(b) a second component that is water or a compound A2 comprising in its molecular formula a plurality of thiol groups or masked precursors thereof;
(c) a third component that is a compound A3 comprising in its molecular formula one or more moieties of formula (II) 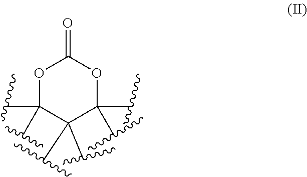 [SMILES: *C1(*)OC(=O)OC(*)(*)C1(*)*]
wherein each wavy line represents the position to which the moiety of formula (II) is attached to the remainder of the compound of formula A3;
(d) optionally, a polyol compound, and
(e) optionally, a catalytically effective amount of a catalyst suitable for the reaction of water or a thiol group of the compound A2 with an aliphatic carbon atom of the moiety of formula (I) in the compound A1.

2. The composition according to claim 1, wherein the molar amounts of compound A2 thiol groups or water hydroxyl groups to compound A1 moieties of formula (I) is from 0.8:1.0 to 1.0:0.8.

3. The composition according to claim 1, wherein the second component is a compound A2.

4. The composition according to claim 1, wherein the compound of formula A1 is a compound of formula (Ib) 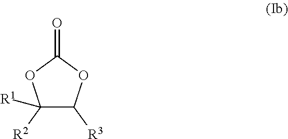
wherein each one of R¹, R² and R³ is independently selected from the group consisting of hydrogen, halo, (C₁-C₆)alkyl, (C₂-C₆)alkenyl, benzyl and (C₃-C₈)cycloalkyl.

5. The composition according to claim 1, wherein A3 is a compound of formula (IIa) 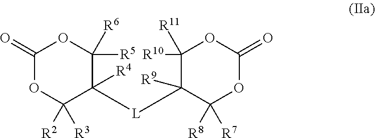
wherein each one of R², R³, R⁴, R⁵, R⁶, R⁷, R⁸, R⁹, R¹⁰ and R¹¹ is independently selected from the group consisting of hydrogen, halo, (C₁-C₆)alkyl, (C₂-C₆)alkenyl and (C₃-C₈)cycloalkyl; and
L is a diradical deriving from a group selected from the group consisting of (C₁-C₆)alkyl, (C₁-C₆)alkyloxy, (C₁-C₆)alkylamino, (C₁-C₆)alkyloxycarbonyl, (C₁-C₆)alkylaminocarbonyl, (C₁-C₆)alkylcarbonylamino, (C₁-C₆)alkylcarbonyloxy, (C₁-C₆)alkylthio, (C₂-C₆)alkenyl, a group of formula (C₁-C₆)alkyl-O—(C₁-C₆)alkyl, a radical of formula (C₁-C₆)alkyl-S—(C₁-C₆)alkyl, a group of formula (C₁-C₆)alkyl-NR¹²—(C₁-C₆)alkyl wherein R¹² is hydrogen or (C₁-C₆)alkyl, a group of formula (C₁-C₆)alkyl-CONR¹²—(C₁-C₆)alkyl wherein R¹² is hydrogen or (C₁-C₆)alkyl, a group of formula (C₁-C₆)alkyl-NR¹²CO—(C₁-C₆)alkyl wherein R¹² is hydrogen or (C₁-C₆)alkyl, a group of formula (C₁-C₆)alkyl-OCO—(C₁-C₆)alkyl, a group of formula (C₁-C₆)alkyl-COO—(C₁-C₆)alkyl, a group of formula (C₁-C₆)alkyl-(O—(C₁-C₆)alkyl)ₙ-O wherein n is an integer of from 1 to 10, a group of formula G, a group of formula (C₁-C₆)alkyl-G, a group of formula (C₁-C₆)alkyl-G-(C₁-C₆)alkyl, wherein G is a ring system comprising from 1 to 3 rings.

6. The composition according to claim 1, wherein A2 is a compound of formula C(H)ₓ(-Q-SH)_{y} wherein each Q is independently a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10; y is an integer from 2 to 4 and x is an integer from 0 to 2, such that the sum of x and y is equal to 4.

7. The composition according to claim 1, comprising a polyol compound selected from the group consisting of a polyether-polyester co-polymer polyol compound, aromatic polyols, Priplast™ 3162, Cardolite™ NX-9004, a (C₁-C₆)alkane comprising at least one carbon atom attached to three or four radicals of formula —CH₂OR¹³ wherein each R¹³ group is independently selected from hydrogen, a polyethylene glycol chain and a polyester chain such as a polycaprolactone chain, and mixtures thereof.

8. The composition according to claim 1, comprising a catalytically effective amount of 1,8-diazabicyclo[5.4.0]undec-7-ene.

9. The composition according to claim 1, wherein the molar amount of compound A3 moieties of formula (II) to moieties of formula (I) in the compound A1 is between 1.5:1 and 5:1.

10. The composition according to claim 1, further comprising an additive selected from the group consisting of inorganic fillers, and cross-linking agents.

11. The composition according to claim 1, having a viscosity of between 20 Pa·s and 500 Pa·s when measured after a time of 540 seconds of heating said composition at 70° C.

12. A process for the preparation of a polycarbonate foam, said process comprising the steps of:
(i) providing a composition comprising the compound A1, water or the compound A2 and the compound A3, said compounds being as defined in claim 1,
(ii) optionally, heating the composition resulting from (i) so as to provide a liquid composition,
(iii) add a catalytically effective amount of a catalyst as defined in claim 1 to the composition resulting from (i) or (ii), and
(iv) heating the composition provided in step (iii) so as to produce a polycarbonate foam.

13.-14. (canceled)

15. A polycarbonate foam comprising in its molecular formula at least one moiety of formula (IV) 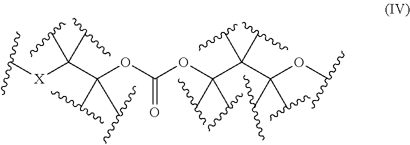
wherein X is S or O.

16.-20. (canceled)

21. The composition according to claim 1, wherein the compound of formula A1 is a compound of formula (Ia) 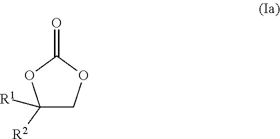
wherein each one of R¹, R² is independently selected from the group consisting of hydrogen, halo, (C₁-C₆)alkyl, (C₂-C₆)alkenyl and (C₃-C₈)cycloalkyl.

22. The composition according to claim 5, wherein the compound of formula A3 is a compound of formula (IIa) wherein each one of R², R³, R⁴, R⁵, R⁶, R⁷, R⁸, R⁹, R¹⁰ and R¹¹ is independently selected from the group consisting of hydrogen, (C₁-C₆)alkyl, and (C₃-C₈)cycloalkyl and L is a diradical deriving from a group selected from the group consisting of (C₁-C₆)alkyl, (C₁-C₆)alkyloxy, (C₁-C₆)alkyloxycarbonyl, (C₁-C₆)alkylcarbonyloxy, a group of formula (C₁-C₆)alkyl-O—(C₁-C₆)alkyl, a group of formula (C₁-C₆)alkyl-OCO—(C₁-C₆)alkyl, and a group of formula (C₁-C₆)alkyl-COO—(C₁-C₆)alkyl.

23. The composition according to claim 1, wherein A3 is 5,5′-(oxybis(methylene))bis(5-ethyl-1,3-dioxan-2-one) of formula (IIa1)

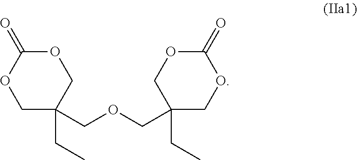 [SMILES: CCC1(COCC2(CC)COC(=O)OC2)COC(=O)OC1]

24. The composition according to claim 1, wherein the compound of formula A2 is
a compound of formula (III) 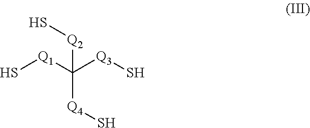
wherein each one of Q₁, Q₂, Q₃ and Q₄ is independently a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10;
or of formula CH₂(Q₁SH)(Q₂SH) wherein each one of Q₁ and Q₂ is independently a diradical deriving from a radical selected from the group consisting of (C₁-C₆)alkyl, (C₁-C₆)alkyloxy, (C₁-C₆)alkyloxycarbonyl, (C₁-C₆)alkylaminocarbonyl, (C₁-C₆)alkylcarbonylamino, (C₁-C₆)alkylcarbonyloxy, and a group of formula (C₁-C₆)alkyl-(O—(C₁-C₆)alkyl)ₙ-O wherein n is an integer of from 1 to 10.

25. The composition according to claim 1, wherein the compound of formula A2 is pentaerythritol tetrakis(3-mercaptopropionate) or 3,6-dioxa-1,8-octanedithiol.

26. The polycarbonate foam according to claim 15, wherein the moiety of formula (IV) is a moiety of formula (IVa) 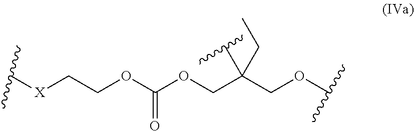
wherein each wavy line represents the position to which the moiety of formula (IV) or (IVa) is attached to the remainder of the polycarbonate foam.

27. The composition according to claim 10, wherein the inorganic fillers are nanoclays and the cross-linking agents are polyepoxy compounds of the polysiloxane type.
